(19) United States
(12) Patent Application Publication
(10) Pub. No.: US 2026/0178348 A1
(43) Pub. Date: Jun. 25, 2026

(54) Late Binding and Package Translation for Multi-Cloud Deployment Using Generative Artificial Intelligence

(71) Applicant: Dell Products L.P., Round Rock, TX (US)

(72) Inventors: Bharath Rathinam, Singapore (SG); Michael Behan, Roscommon (IE)

(21) Appl. No.: 18/988,810

(22) Filed: Dec. 19, 2024

(51) Int. Cl. G06F 9/445; G06F 8/60

(52) U.S. Cl. CPC G06F 9/44521; G06F 8/60; G06F 9/44505

(57) ABSTRACT

A system can determine to execute an application via a selected computing platform, wherein the application comprises a deployment manifest. The system can determine a capability of capabilities of the selected computing platform based on capability models and the deployment manifest. The system can modify the deployment manifest based on the capability to produce a modified deployment manifest, wherein the modifying comprises prompting a generative artificial intelligence (GenAI) system to produce a response comprising the modified deployment manifest and a group of steps to perform, and determining that the response satisfies an accuracy criterion with respect to an accuracy of the modified deployment manifest in facilitating execution of the application on the selected computing platform. The system can configure the capability based on the modified deployment manifest. The system can instantiate the application via the selected computing platform with the modified deployment manifest and according to the group of steps.

### BACKGROUND

Applications can be instantiated on telecommunications clusters. A retrieval-access generation (RAG) system can generally comprise a large language model (LLM) that operates on a specific information set (e.g., a set of documents) so that the LLM is configured to respond to queries based on that information set. An LLM can generally comprise a form of generative artificial intelligence (AI) that is configured to generate natural-language response outputs to natural-language query inputs.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine to execute an application via a selected computing platform of a group of computing platforms, wherein the application comprises a deployment manifest. The system can determine a capability of capabilities of the selected computing platform based on capability models and the deployment manifest, wherein the capability models are determined based on modeling respective capabilities of respective computing platforms. The system can modify the deployment manifest based on the capability to produce a modified deployment manifest, wherein the modifying comprises prompting a generative artificial intelligence system to produce a response, wherein the response comprises the modified deployment manifest and a group of steps to perform to instantiate the application via the selected computing platform, and wherein the generative artificial intelligence system is tuned to generate manifests and configuration changes, and determining that the response satisfies an accuracy criterion with respect to an accuracy of the modified deployment manifest in facilitating execution of the application on the selected computing platform. The system can configure the capability corresponding to specifications of the application identified in the modified deployment manifest. The system can instantiate the application via the selected computing platform with the modified deployment manifest and according to the group of steps.

An example method can comprise determining, by a system comprising at least one processor, to execute an application via a selected computing platform of a group of computing platforms, wherein the application comprises a deployment manifest. The method can further comprise determining, by the system, a capability of capabilities of the selected computing platform based on capability models and the deployment manifest, wherein the capability models are determined based on modeling respective capabilities of respective computing platforms manifest. The method can further comprise inputting, by the system, the deployment manifest and the capability to a generative artificial intelligence system to produce a response, wherein the response comprises a modified deployment manifest and steps to perform to instantiate the application via the selected computing platform. The method can further comprise determining, by the system, that the response satisfies a predetermined accuracy criterion with respect to an accuracy of the modified deployment manifest in facilitating execution of the application on the selected computing platform manifest. The method can further comprise configuring, by the system, the capability corresponding to specifications of the application identified in the modified deployment manifest. The method can further comprise instantiating, by the system, the application via the selected computing platform with the modified deployment manifest and based on the steps.

An example non-transitory computer-readable medium can comprise instructions that, in response to execution, cause a system comprising a processor to perform operations. These operations can comprise determining a capability of a computing device based on a capability model of the computing device and a deployment manifest for an application. These operations can further comprise, based on the deployment manifest and the capability, prompting a generative artificial intelligence system to produce a response, wherein the response comprises a modified deployment manifest and steps to perform. These operations can further comprise determining that the response satisfies an accuracy criterion with respect to an accuracy of the modified deployment manifest in facilitating execution of the application via the computing device. These operations can further comprise configuring the capability corresponding to specifications of the application identified in the modified deployment manifest. These operations can further comprise instantiating the application via the computing device with the modified deployment manifest and based on the steps to perform.

### BRIEF DESCRIPTION OF THE DRAWINGS

The present examples generally relate to generative artificial (GenAI) systems. These can include GenAI models, RAGs, LLMs, and other types of technologies that can generate text output based on an input.

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate late binding and package translation for multi-cloud deployment using GenAI, in accordance with an embodiment of this disclosure;

FIG. 2 illustrates an example system architecture for late-binding of an application to a cluster, and that can facilitate late binding and package translation for multi-cloud deployment using GenAI, in accordance with an embodiment of this disclosure;

FIG. 3 illustrates an example table of cluster capabilities, and that can facilitate late binding and package translation for multi-cloud deployment using GenAI, in accordance with an embodiment of this disclosure;

FIG. 4 illustrates an example application manifest, and that can facilitate late binding and package translation for multi-cloud deployment using GenAI, in accordance with an embodiment of this disclosure;

FIG. 5 illustrates another example table of cluster capabilities, and that can facilitate late binding and package translation for multi-cloud deployment using GenAI, in accordance with an embodiment of this disclosure;

FIG. 6 illustrates an example system architecture for power savings using application specific power and performance (C/P) states tuning, and that can facilitate late binding and package translation for multi-cloud deployment using GenAI, in accordance with an embodiment of this disclosure;

FIG. 7 illustrates an example system architecture for processor power optimization, and that can facilitate late binding and package translation for multi-cloud deployment using GenAI, in accordance with an embodiment of this disclosure;

FIG. 8 illustrates an example signal flow for deployment manager interactions, and that can facilitate late binding and package translation for multi-cloud deployment using GenAI, in accordance with an embodiment of this disclosure;

FIG. 9 illustrates an example signal flow that can facilitate late binding and package translation for multi-cloud deployment using GenAI, in accordance with an embodiment of this disclosure;

FIG. 10 illustrates more of an example signal flow that can facilitate late binding and package translation for multi-cloud deployment using GenAI, in accordance with an embodiment of this disclosure;

FIG. 11 illustrates more of an example signal flow that can facilitate late binding and package translation for multi-cloud deployment using GenAI, in accordance with an embodiment of this disclosure;

FIG. 12 illustrates more of an example signal flow that can facilitate late binding and package translation for multi-cloud deployment using GenAI, in accordance with an embodiment of this disclosure;

FIG. 13 illustrates an example process flow that can facilitate late binding and package translation for multi-cloud deployment using GenAI, in accordance with an embodiment of this disclosure;

FIG. 14 illustrates another example process flow that can facilitate late binding and package translation for multi-cloud deployment using GenAI, in accordance with an embodiment of this disclosure;

FIG. 15 illustrates another example process flow that can facilitate late binding and package translation for multi-cloud deployment using GenAI, in accordance with an embodiment of this disclosure;

FIG. 16 illustrates an example power profiles definition, and that can facilitate late binding and package translation for multi-cloud deployment using GenAI, in accordance with an embodiment of this disclosure;

FIG. 17 illustrates an example system architecture for dynamic configuration switching, and that can facilitate late binding and package translation for multi-cloud deployment using GenAI, in accordance with an embodiment of this disclosure;

FIG. 18 illustrates an example system architecture for instantiating an application on a cluster type a first time, and that can facilitate late binding and package translation for multi-cloud deployment using GenAI, in accordance with an embodiment of this disclosure;

FIG. 19 illustrates an example system architecture for instantiating an application on a cluster type a subsequent time, and that can facilitate late binding and package translation for multi-cloud deployment using GenAI, in accordance with an embodiment of this disclosure;

FIG. 20 illustrates an example block diagram of a computer operable to execute an embodiment of this disclosure.

### DETAILED DESCRIPTION

### Overview

The present examples generally relate to power management settings for applications in a telecommunications network. It can be appreciated that these are illustrative examples, and that the present techniques can be applied more generally to capabilities of different computing clusters that can be utilized by applications that are deployed to those clusters. A cluster can generally comprise a group of computing nodes that are configured to execute a containerized application. A container can comprise an isolated runtime environment, and a containerized application can comprise a plurality of microservices each executing in a respective container. It can be appreciated that this is one example architecture, and the present techniques can be implemented with different architectures to facilitate late binding and package translation for multi-cloud deployment using GenAI.

The present examples also generally relate to applications deployed in one or more containers on a computing cluster (which can comprise a group of computers working together such that they can logically be viewed as one computer, or in other examples, one computer) in a telecommunications context (e.g., to facilitate broadband cellular communications), where power management can be important. It can be appreciated that these are illustrative examples, and that the present techniques can be applied more generally to different types of late-binding between an application and a computing platform that the application will run on in application instantiation.

In some prior approaches, telecom systems comprised pre-assembled “appliances,” where an application and hardware on which the application was deployed were early-binded at the factory.

In some more-recent prior approaches utilizing cloud-ified information technology (IT) systems, it can be that an application has no special capability requirements to make on a cloud platform. That is, the platforms can usually be large enough to cope with application demands.

Then, more recently than that, prior approaches to a telecom scenario can use cloud platforms that are smaller and widely distributed compared to the cloud-ified IT systems. The applications can have specific capability requirements in terms of performance, network latency, power management, etc. It can be that these telecom applications are not usually deployable on typical general-purpose cloud platforms.

It can be that prior approaches fail to meet late-binding needs of both telecom and general purpose IT applications and platforms. In contrast, the present techniques can facilitate late-binding via a model-based approach to provide just-in-time reconfiguration of both an application and its platform. Previously, telecom cloud applications have depended on knowing exact platform capabilities, which can run counter to cloud principles. The present techniques can remove this burden of application vendors knowing exact platform capabilities for designing their applications, and can automate a late-binding and reconfiguration process of applications.

In a telecommunications scenario, it can be that prior approaches to orchestration of applications can assume that an application package designer has a prior understanding of a target cluster's capabilities. For example, there can be work done in an Open Radio Access Network (O-RAN) working group to standardize certain capabilities (e.g., profiles), but this has not been applied to C/P states. It can be that standards do not define all capabilities that exist now, or in the future, as that could impede innovation by both software and hardware manufacturers.

It can be that a cluster capabilities requirement expressed in an application package can be used for placement (e.g., selection of suitable cluster(s) among multiple clusters).

Application manifests (which can generally comprise metadata about a corresponding information, such as which capabilities of a cluster on which the application is to be installed the application will utilize) created by a designer can identify resource specifications, but they can also be expected to comprise attributes to request resources of a specific type based on capabilities, custom resources and/or cluster controllers of a target cluster.

A problem can occur where an application provider might not have prior knowledge of specific resource types onboarded on the actual cluster(s), such as for optional features like power-management.

It can be that used resources types like accelerators, single-root input output virtualization (SRIOV), etc., can have some standardized capabilities. For example, there can be a vendor-specific power-manager deployed on a target cluster as a cluster controllers (e.g., custom resources) that can expose different resources based on implementation, and vary from one vendor to another. Using a power-management example, it can be that an application package needs to contain attributes for a vendor-specific (custom resources) power-manager in the application manifest for placement and deployment. This requirement can necessitate that an application provider provides a cluster controller-specific application package, or explores an alternate approach to standardize and abstract all such cluster controllers.

A problem with both of these approaches can be that they are impractical in a multi-cloud environment, and create tight binding between the target environment and the application package.

Additionally, there can be a need for a deployment manager (e.g., a virtual network functions manager (VNFM)) to tune application manifests based on a target cluster's capabilities at a time of deployment, which can free up this decision at the design time.

The present techniques can be implemented to facilitate pre-populating deployment manifests from an application vendor, capability (e.g., power management) modules from a cluster vendor, and a user's policies for capability (e.g., power profile) selection at runtime.

When instantiating an application on a target cluster, a deployment manager can check a catalog for pre-existing deployment modifiers. If none are available, the policy manager can select a most appropriate (or by some other criteria) normalized profile for the cluster type. The deployment manager can use the profile to modify or decorate the deployment descriptor before activating the instantiation request on the cluster.

An advantage of the present techniques can be that they are not technology dependent. That is, they can be applied to different cluster types and different power managers. It can be appreciated that, while the present examples generally relate to CPU power control and optimization, the present techniques can be applied to capabilities offered by clusters.

The present techniques can be implemented to facilitate late-binding of an application in conjunction with infrastructure-specific configurations; that is, infrastructure configuration can be performed in conjunction with application-specific customization.

A default power profile at instantiation time can be provided by an attribute, and a policy to switch between power profiles can be provided along with a VNFD so a VNFM can decide to switch when auto_power_switch is enabled.

The present techniques can also be implemented to facilitate reusability. Where a subsequent instantiation is performed for an application, but for a different cluster type than before, a new modified descriptor can be generated. However, where this second instantiation is being performed for a similar cluster type with similar capabilities, then the pre-existing descriptor can be used in the second instantiation, which can save time and processing resources.

In some examples, components involved in late-binding and package translation can be included in a deployment manager/VNFM controlled by a higher-layer orchestration system, such as a network function virtualization orchestrator (NFVO).

These components can aid with realizing a system where the lower-level cluster capabilities (e.g., cluster controllers) in use need not be standardized or exposed to higher-layer orchestration systems.

The present techniques can be implemented to enable a vendor to provide a common application package irrespective of the cloud capabilities in-place, and reduce a designing and testing overhead.

In some examples, the present techniques can facilitate a deployment manager prompting an LLM (or other GenAI system) to obtain a solution for instantiating an application on a particular cloud platform (e.g., performing a dynamic translation of cluster capabilities. An example deployment manager can coordinate and implement solutions provided by an LLM (that is, to customize the infrastructure capabilities as per application requirements), and create final modified manifests based on individual pieces of attributes suggested by LLM(s) (that is, modify application manifests to suit modified cluster capabilities). There can be a negotiation capability in the deployment manager to gauge an accuracy of a response from an LLM.

While the present examples generally relate to a LLM, in some examples, generative AI (GenAI) techniques other than a LLM can be implemented to facilitate late binding and package translation for multi-cloud deployment using GenAI generally, and/or obtaining a solution for instantiating an application on a particular cloud platform more specifically. For instance, there can be examples that implement a RAG.

In some examples, abstraction and late binding can be utilized to allow application packages to be deployed without detailed knowledge of a cluster's capabilities.

In contrast, the present techniques can involve leveraging generative artificial intelligence (AI), which can utilize a knowledge base (and/or a RAG) and fine-tuning processes. The present techniques can be implemented to automatically convert abstract application packages into cluster capability-specific manifests, which can ensure successful deployment and optimal (or satisfactory) performance of applications within the cluster through late-binding.

The present techniques can be implemented with retrieval-augmented generation (RAG)-based generative AI functionalities. This integration can enable a translation of a cloud-agnostic vendor package into a cluster-specific application package.

Additionally, the present techniques can facilitate an extraction of customization steps to tailor cluster capabilities to application requirements, using generative AI-derived intents. These intents can subsequently be converted into actionable directives within the cluster by a deployment manager. An intent can generally indicate a high-level procedure or objective that specifies what is to be achieved within the cluster and/or application manifest. In some examples, then a deployment manager can handle implementing those intents on the cluster to achieve that desired result.

A deployment manager can comprise a component to coordinate the translation of individual capabilities with the out of the box features of a RAG based large language model (LLM). In some examples, a responsibility to convert the intents from LLMs and execute them in relevant order and assembling the final application manifests that can be used to create a temporary package can lie with the deployment manager.

An intelligent deployment manager can integrate with customized LLMs (and/or other generative AI approaches, such as those that utilize a RAG, a prompt router, etc.) in a telco environment.

In some examples, the present techniques can be implemented with some, or all, of the following components.
A target cluster with cluster controllers (such as a power-manager, etc.) deployed with their default configurations (e.g., without any special profiles for application) where the application will be deployed. The target cluster can expose its capability (e.g., cluster controllers in use, their version) to an infra management system.
A central ops LLM can house multiple customized and fine-tuned large language models (LLMs) that operate concurrently to address a variety of operational use cases. A central ops LLM can comprise a prompt router and evaluator system, steps and config LLMs, and manifest LLMs.
   A prompt router and evaluator system (e.g., an LLM Gateway) can be responsible for receiving prompts from different consumers, breaking the prompts down, and routing them to the appropriate LLM based on a pre-configured logic (fed as configurations). The prompt router and evaluator system can be capable of evaluating the accuracy of responses from a RAG system using predefined metrics like Correctness, ContextRelevance, and Groundedness, and relaying these evaluations back to the consumer by embedding them as a part of a response to the query.
   Steps and config LLMs can comprise a RAG-based system that utilize documentation specific to cluster controllers (e.g., loaded into a vector database (DB)) to provide steps and configurations on the target cluster where an application is deployed.
   Manifest LLMs can comprise fine-tuned LLMs based on prompts that generate application attributes or config blobs used by an application to refer to the cluster controllers. These blobs of the manifests can be part of the final manifests (like containerized applications charts) that can reference the configuration created in the cluster to effectively utilize cluster controllers for specific applications.
   In some examples, an ops team managing a central ops LLM can keep a RAG system updated with relevant and the latest documentation of controllers. The fine-tuning of the LLMs can occur regularly based on changes in the controllers and feedback from a production system. In other words, it can be that a lifecycle management (LCM, which can comprise updating a LLM, retraining the LLM, etc.) of the central ops LLM can be taken care of, as this can help decouple a dependency to update the deployment manager software when there is a change in a cluster controller.
   In some examples, one entity can use the LLM while a different entity handles an LLM training and fine-tuning process. It can be that an infra orchestrator and deployment manager according to the present techniques can integrate with an LLM that is created by operators/vendors
An infra management system can execute instructions received from a deployment manager to customize the infrastructure, for example, to create custom power-profiles for the application (that is, there can be other controller implementations and scenarios where application-based modification can be performed according to the present techniques). The infra management system can keep an inventory of cluster capabilities and associated metadata, such as a version, along with other relevant inventory of clusters it manages. The infra management system can pass this capability information onto the deployment manager on demand.
A deployment manager can receive a deployment request along with a generic application package, and deploy the application in the target cluster along with facilitating performing customizations on the target cluster (e.g., by modifying the cluster capabilities/controllers) for optimal (or satisfactory) performance of the application.
   The deployment manager can parse an application package, and determine a translation of certain abstract capabilities (such as power profile, accelerator profile, etc.) expressed in the application package is to be performed.
   Based on programmed logic, the deployment manager can create pre-engineered prompts to involve the central ops LLM in generating the steps and translations to handle evolving/updated infrastructure capabilities.
   An example prompt can be: “Create necessary steps for the infra to handle $power-profile expressed in the application manifests in the cluster where $power-manager with version $2.3.1 is deployed, and create $translations in the application manifest to handle the $power-manager with version $2.3.1. The manifest with the abstract $power-profile entries are $ {part of the application package} . Provide the following evaluations measurements of the response $accuracy, groundedness etc.
   Variables identified in the with a leading “$” can be overridden or replaced during creation of prompts from pre-engineered templates.
The deployment manager can perform translations in a loop for the components of the application package (e.g., VDUs of the VNFDs) and for cluster capabilities. The Central Ops LLMs can respond back with steps and translations as solutions/intents along with the requested accuracy measurements.
The deployment manager can use a pre-determined accuracy criteria/requirement of the translations to gauge the evaluation measurements and reattempt the translation process if the measurements do not satisfy the criteria. In some examples, a max_number_of_attempts counter can be used to limit a number of retries.
The deployment manager can use these independent responses from the ops LLM (in the form of customization steps for infra and config blobs for the manifests) in a sequence determined by the deployment order of the components (e.g., VDUs of the VNFD).
The deployment manager can then execute the workflow to customize the infrastructure as determined by the sequence (e.g., to create unique power-profile configurations for the application). It can also put together the consolidated application manifests (e.g., a helm package and VNFD) based on the independent config blobs received from the ops LLM.
The deployment manager can create a temporary package with these customizations suited for the infrastructure, and can use this temporary package for application deployment in the cluster, which is already customized for the application requirements.

The following is an example workflow according to the present techniques that utilizes a RAG-based GenAI approach.

Before the workflow, a step can involve inputting relevant controller(s) documents, manuals and steps as vector embeddings into a vector DB. This can also include software development kids (SDKs) and or application programming interfaces (APIs).

Another initial step can involve creating a fine-tuned manifest generation LLM based on the relevant sample data-sets containing controller(s) references.

An example workflow in a power-profile controller scenario (where there are other controller implementations and scenarios where application-based modification can be performed according to the present techniques) comprises:
1. Instantiate a VNF with VNFD-ID (where the VNFD can comprise abstract power-profiles and accelerator profiles supported, for example).
2. The deployment manager parses and processes the VNFD. The deployment manager determines that the power-profile and accelerator profile is to be translated.
2.1. The deployment manager fetches the cluster capabilities, such as the deployed power-manager and accelerator.
2.2. The deployment manager sends pre-engineered prompt(s), the controller used (e.g., a power manager type and an accelerator type), and manifests (charts),
   2.2.1. To retrieve the steps and configurations used to customize the infra, and
   2.2.2. To provide the manifest of the application for the controller(s). A prompt router can break down the tasks, and route the prompts to relevant LLMs.
3. Generate the steps and configuration to customize the infrastructure based on the controller used and power-profiles in the application manifest.
4. Generate the corresponding manifests based on the power manager type using the manifests available in VNFD.
4.1 Create accuracy measurements of the responses.
5. Share the intent to the deployment manager, comprising
   5.1. Steps to follow in the infrastructure to customize, and
   5.2. Configurations to apply in the cluster.

In some examples, there can be an exception where a reattempt is performed if an accuracy score is less than a predetermined threshold value. This threshold value can indicate a minimum confidence that the output is correct.
6. Modified manifests based on the corresponding controller(s) and attributes can be available in the VNFD.
7. Intent management can be performed, which can comprise converting an intent received from an LLM to corresponding actions via an infra-manager.
7.1 The infra-manager can implement the changes in the infrastructure.
8. Create the final manifests based on LLM and other relevant translations.
8.1 Push the modified manifest and VNFD to the catalogue.
8.2 Use the temp manifest in VNFD to deploy the application in the cluster that has relevant infra configurations loaded.

The present techniques can be implemented to facilitate interaction between a deployment manager and a generative AI system.

An LLM approach according to the present techniques can be flexible, and can facilitate decoupling of a deployment manager from changes on the cluster controllers.

In some examples, an ops team managing a central ops LLM can keep the RAG system updated with the relevant and latest documentation of controllers. The fine-tuning of the LLMs can occur regularly based on the changes in the controllers and feedback from the production system. That is, the LCM of the central ops LLM can be managed, and this can decouple a dependency to update the deployment manager software when there is a change in a cluster controller.

This approach, according to the present techniques, can also be economical. Additionally, this approach can remove a need to update the distributed deployment manager with a translator package, as the central ops LLM can be updated with relevant docs and a fine-tuned model.

### Example Architectures, etc.

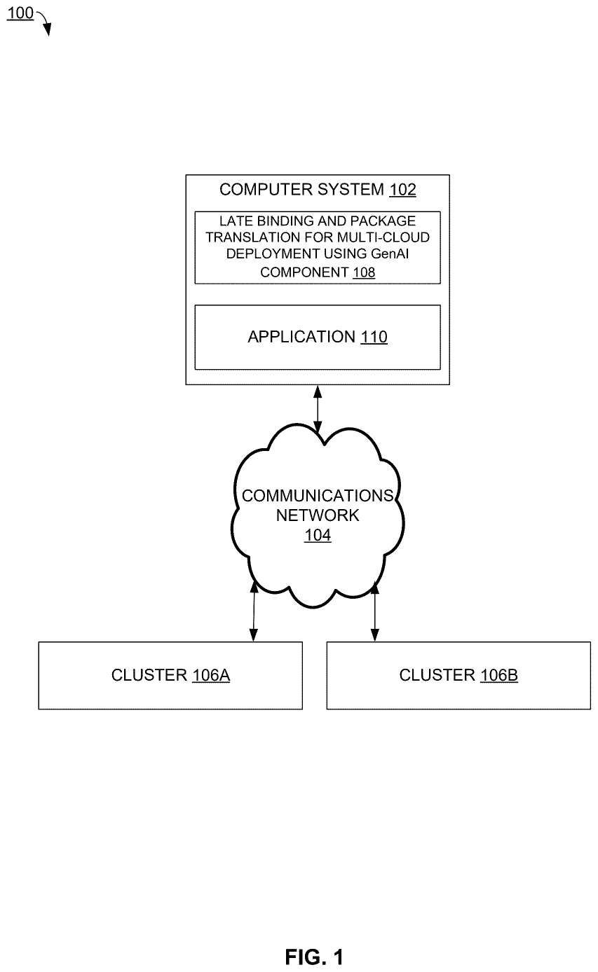

FIG. 1 illustrates an example system architecture 100 that can facilitate late binding and package translation for multi-cloud deployment using GenAI, in accordance with an embodiment of this disclosure.

System architecture 100 comprises computer system 102, communications network 104, and cluster 106A and cluster 106B. In turn, computer system 102 comprises late binding and package translation for multi-cloud deployment using GenAI component 108, application 110, LLM 112, and deployment manager 114.

System architecture 100 presents one logical example of implementing the present techniques, and it can be appreciated that there can be other example architectures.

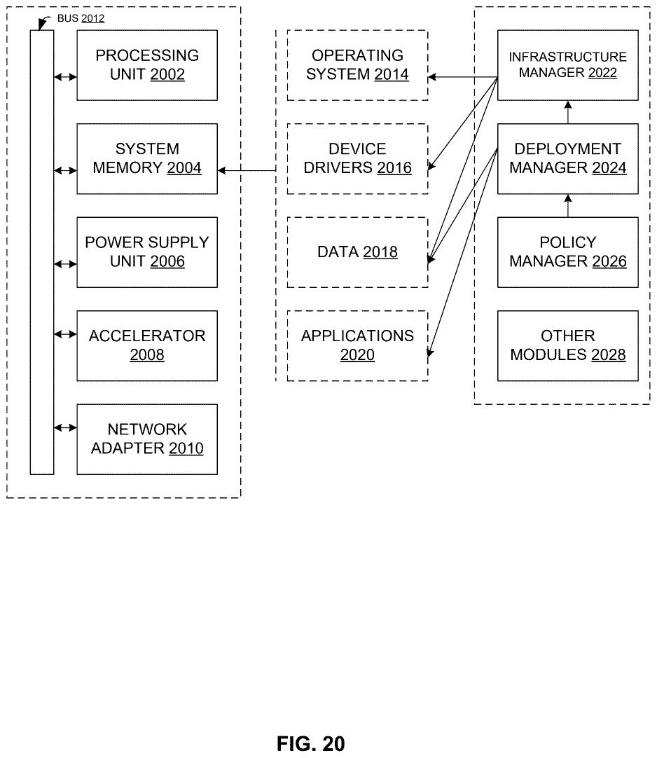

Each of computer system 102, cluster 106A, and/or cluster 106B can be implemented with part(s) of computing environment 2000 of FIG. 20. Communications network 104 can comprise a computer communications network, such as the Internet, or an intranet.

In some examples, late binding and package translation for multi-cloud deployment using GenAI component 108 can facilitate late binding and package translation in instantiating an application (e.g., application 110) on a cluster (e.g., cluster 106A or cluster 106B). To do this, late binding and package translation for multi-cloud deployment using GenAI component 108 can facilitate prompting LLM 112 to produce an output for customizing manifests, implementation steps, etc., where deployment manager 114 evaluates the output to determine whether it is sufficiently likely to be correct. Deployment manager 114 and LLM 112 can engage in iterations of generating and evaluating an output to produce a final output that is used for instantiating application 1120.

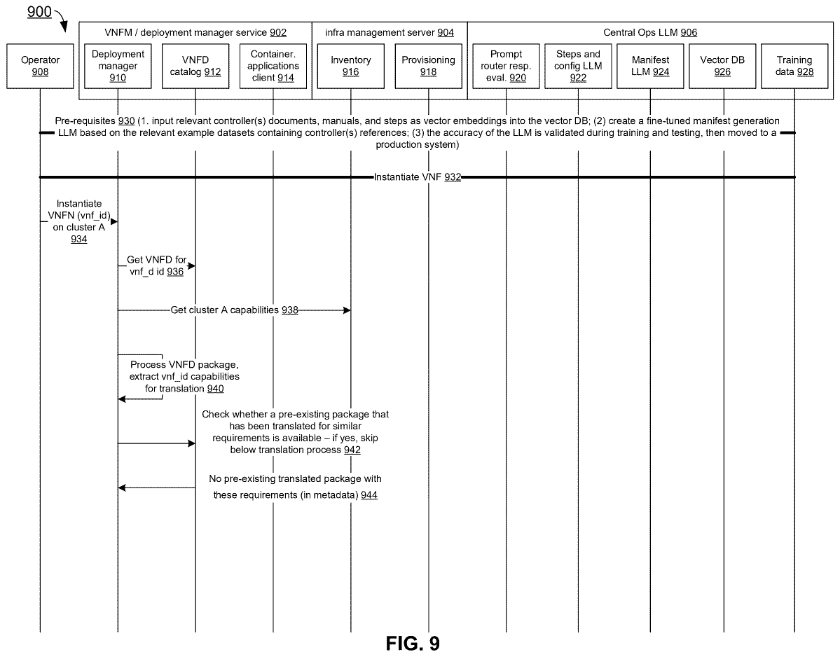

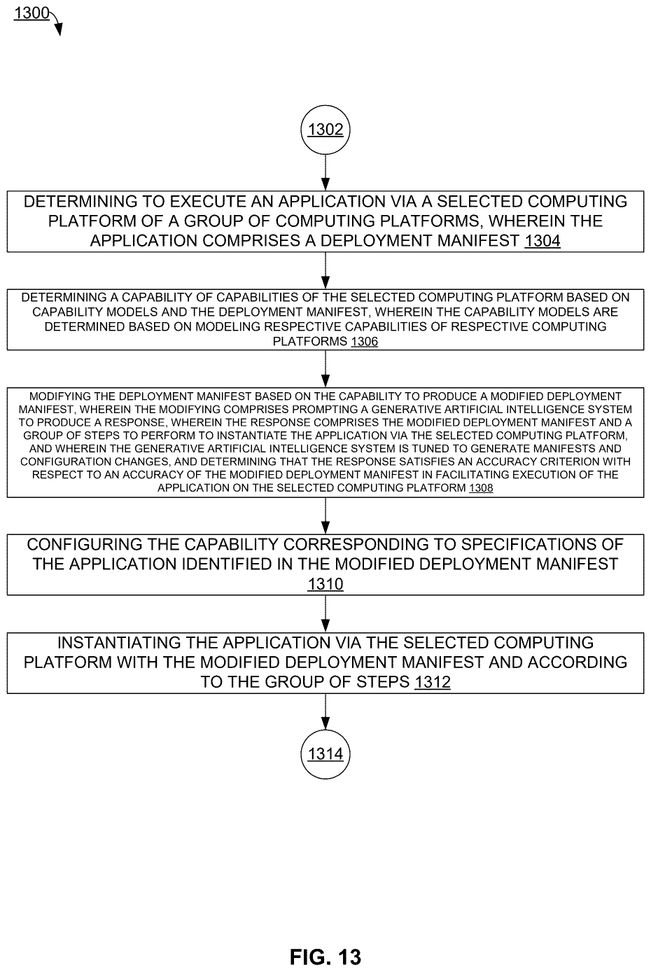

In some examples, late binding and package translation for multi-cloud deployment using GenAI component 108 can implement part(s) of the signal flows of FIGS. 9-12 and/or the process flows of FIGS. 13-15 to implement late binding and package translation for multi-cloud deployment using GenAI.

It can be appreciated that system architecture 100 is one example system architecture for late binding and package translation for multi-cloud deployment using GenAI, and that there can be other system architectures that facilitate late binding and package translation for multi-cloud deployment using GenAI.

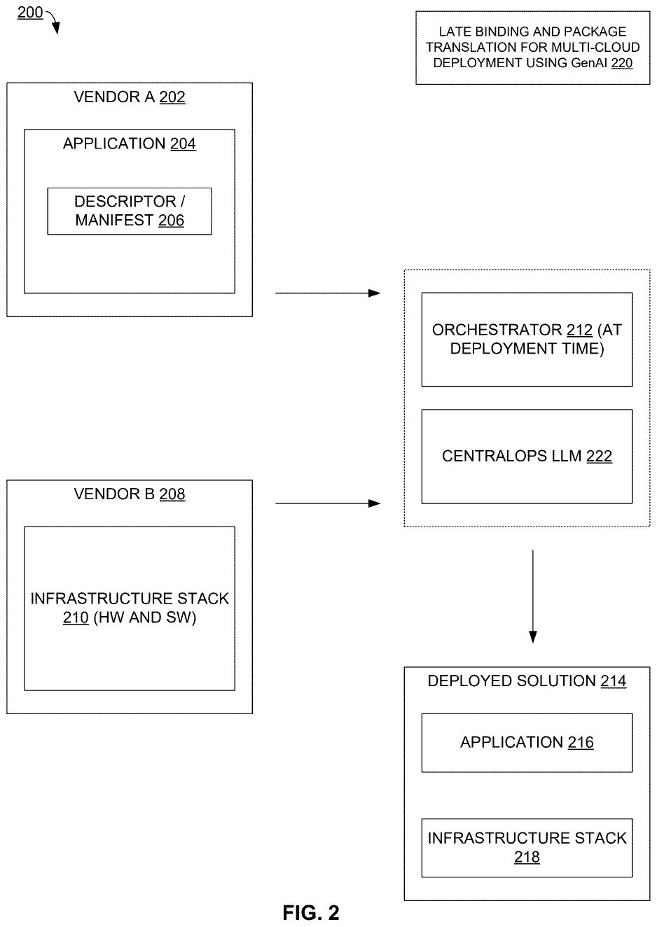

FIG. 2 illustrates an example system architecture 200 for late-binding of an application to a cluster, and that can facilitate late binding and package translation for multi-cloud deployment using GenAI, in accordance with an embodiment of this disclosure. In some examples, part(s) of system architecture 200 can be used to implement part(s) of system architecture 100 of FIG. 1 to facilitate late binding and package translation for multi-cloud deployment using GenAI.

System architecture 200 comprises vendor A 202, application 204, descriptor/manifest 206, vendor B 208, infrastructure stack 210 (hardware and software (HW and SW)), orchestrator 212, deployed solution 214, application 216, infrastructure stack 218, late binding and package translation for multi-cloud deployment using GenAI component 220 (which can be similar to late binding and package translation for multi-cloud deployment using GenAI component 108 of FIG. 1), and CentralOps LLM 222. It can be appreciated that there can be different examples with different architectures, such as an example where CentralOps LLM 222 is part of orchestrator 212.

FIG. 2 generally illustrates an example of “late binding” of an application to a particular infrastructure stack (which can comprise hardware and software). In some examples, late binding can occur at a time that it is determined that a particular application will be deployed to a particular infrastructure stack. Late binding can be viewed in contrast to “early binding,” where binding a particular application to a particular infrastructure stack can occur earlier than late binding, such as at a time that an application is developed, or obtained from a vendor.

Performing late binding can result in postponing needing to know other system components until necessary.

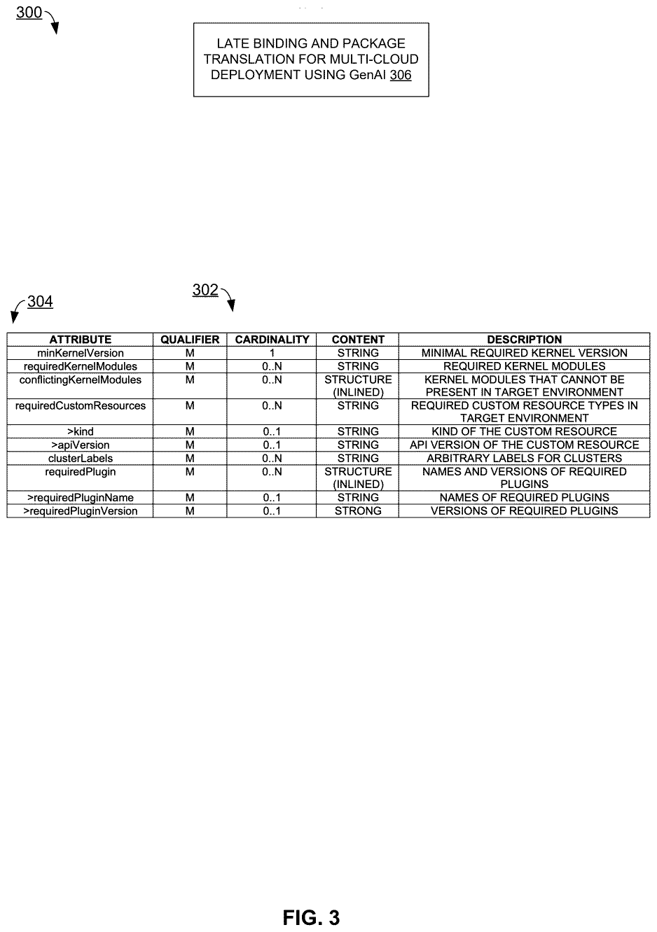

FIG. 3 illustrates an example table 300 of cluster capabilities, and that can facilitate late binding and package translation for multi-cloud deployment using GenAI, in accordance with an embodiment of this disclosure. In some examples, parts of table 300 can reflect parts of prior approaches to application manifests. In some examples, part(s) of table 300 can be used to implement part(s) of system architecture 100 of FIG. 1 to facilitate late binding and package translation for multi-cloud deployment using GenAI.

Table 300 comprises rows 302, columns 304, and late binding and package translation for multi-cloud deployment using GenAI component 306 (which can be similar to late binding and package translation for multi-cloud deployment using GenAI component 108 of FIG. 1). Rows 302 identifies different information elements for enhanced cluster capabilities, and columns 304 provides information about the respective information elements.

In some examples of a network application platform, an application specific descriptor (which can be provided by a vendor/application designer) can expect that the target cluster capabilities (e.g., a custom resources name, version, etc.) are specified as part of a package. This information can be used for placement of the application on a target cluster.

Then, an actual application manifest can have specific resources referenced for fetching similar resources at a time of deployment.

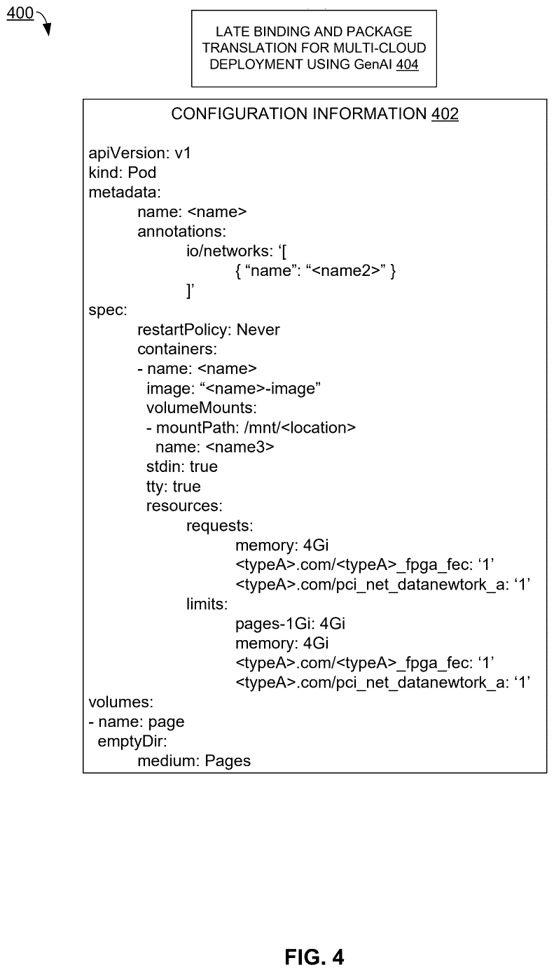

FIG. 4 illustrates an example 400 application manifest, and that can facilitate late binding and package translation for multi-cloud deployment using GenAI, in accordance with an embodiment of this disclosure. In some examples, part(s) of example 400 can be used to implement part(s) of system architecture 100 of FIG. 1 to facilitate late binding and package translation for multi-cloud deployment using GenAI.

Example 400 comprises configuration information 402, and late binding and package translation for multi-cloud deployment using GenAI component 404 (which can be similar to late binding and package translation for multi-cloud deployment using GenAI component 108 of FIG. 1).

Configuration information 402 can be used to identify parts of table 300 as part of an application identifying target cluster specific capabilities.

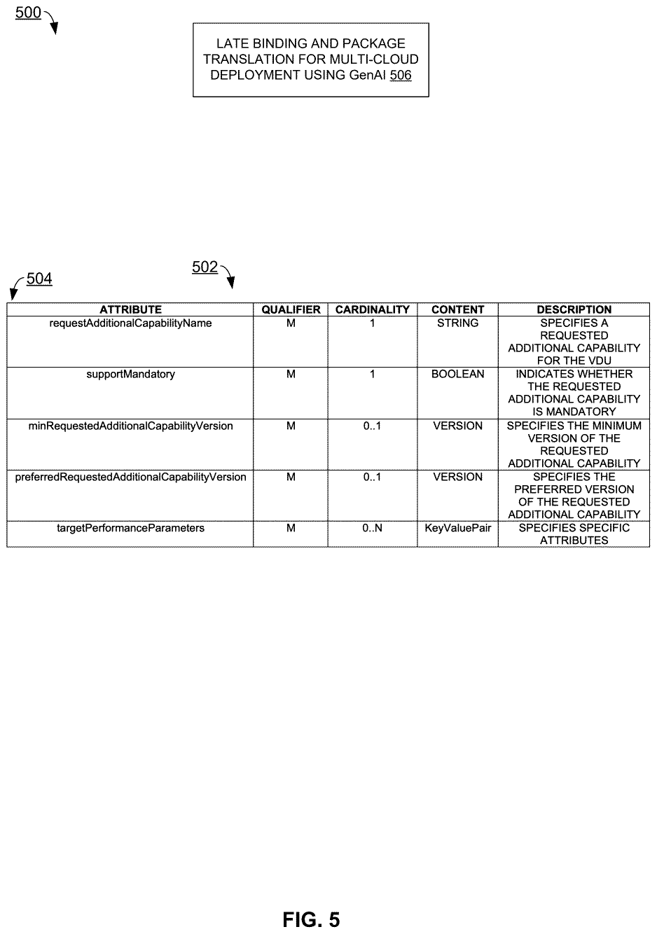

FIG. 5 illustrates another example table 500 of cluster capabilities, and that can facilitate late binding and package translation for multi-cloud deployment using GenAI, in accordance with an embodiment of this disclosure. In some examples, parts of table 500 can reflect parts of prior approaches to application manifests. In some examples, part(s) of table 500 can be used to implement part(s) of system architecture 100 of FIG. 1 to facilitate late binding and package translation for multi-cloud deployment using GenAI.

Table 500 comprises rows 502, columns 504, and late binding and package translation for multi-cloud deployment using GenAI component 506 (which can be similar to late binding and package translation for multi-cloud deployment using GenAI component 108 of FIG. 1). Rows 502 identifies different information elements for enhanced cluster capabilities, and columns 504 provides information about the respective information elements.

The information of table 500 can be similar to that of table 300 of FIG. 3, and presented in a different manner. That is, table 300 and table 500 together can show how different clusters can express their capabilities in different manners.

In table 500, a RequestAdditionalCapability information element where the specific custom resources/additional capability can be expressed with an exact name and version that would be used in the target cluster for the application to work. Using this approach, it can be that there is no abstraction involved, and the application designer should have advanced knowledge of the target cluster capabilities. Table 400 of FIG. 4, and table 500, can generally identify problems with prior approaches that can be addressed through the present techniques.

The present techniques can be implemented to facilitate abstraction and late binding, so that an application package can be provided in an abstract format, without a need for having knowledge of granular cluster-level capabilities.

Using a power manager example, and according to the present techniques, an application package can be designed without a need to know an exact power manager (e.g., a cluster capability that can be provided by a cloud/hardware platform vendor) and its specific workflows and manifests attributes (e.g., component to manage containerized application packages-charts).

A virtual network function descriptor (VNFD)/application package provided by the vendor can provide supported C/P-states of their workloads in an abstract format without implementation specific information.

A deployment manager part of a VNFM, which can be responsible for deploying the application on the target cluster, can translate the abstract power-profiles expressed in the application package to a cluster-controller-specific process and manifest, so that the application can be deployed successfully with relevant information required for the cluster-specific power-controller to work.

In some examples, the present techniques can be implemented as follows, using a power management scenario. A temporary_VNFD package can be created that contains modified application manifests based on the abstract power-profiles and actual cluster specific controllers.

Information about cluster-specific controllers can be stored as a capability of a cluster in an infrastructure manager (at the lower-layers) as key: value pairs. For example:

Cluster_Capability {[Power-manager: <Type>, version==2.3] [resource-optimizer: Descheduler, version: 3.2.1]}

It can be that certain cluster capabilities require a virtual network function (VNF) and/or application-specific modification (e.g., resource customization). In this scenario, a power-manager new custom profile (e.g., supported C/P-states) can be created on target clusters. So, there can be a customization of the infrastructure based on the application requirements.

Application manifests can be modified based on a specific power-manager deployed on a cluster. In this scenario, an additional attribute can be added in the spec.containers.resources.cpu and spec.containers.limits.cpu to reference a custom profile that was created, as described above. So, there can be a customization of the application manifest based on the infrastructure capability in the target cluster.

Hence, the present techniques can be implemented to facilitate a process of modifying a cluster configuration to suit an application's needs, and modifying application manifests based on cluster capabilities at a deployment time rather than at a design time.

According to the present techniques, this can be fluidly handled without a need for modifying VNFM software, and/or an application package, for a particular set of cluster controllers.

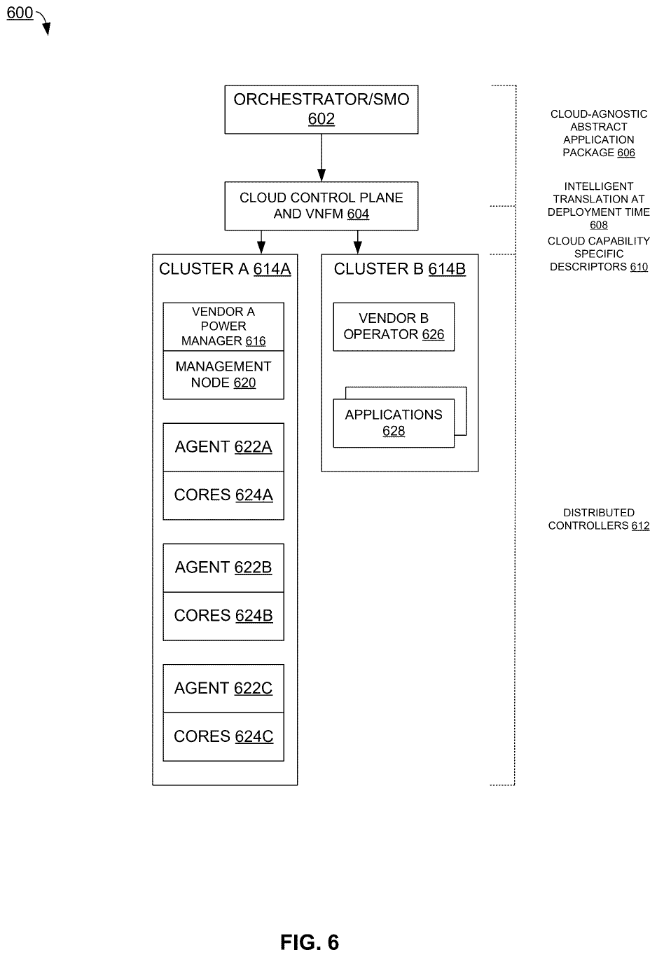

FIG. 6 illustrates an example system architecture 600 for power savings using application specific C/P states tuning, and that can facilitate late binding and package translation for multi-cloud deployment using GenAI, in accordance with an embodiment of this disclosure. In some examples, part(s) of system architecture 600 can be used to implement part(s) of system architecture 100 of FIG. 1 to facilitate late binding and package translation for multi-cloud deployment using GenAI.

System architecture 600 comprises orchestrator/service manager and orchestration (SMO) 602, cloud control plane and VNFM 604, cloud-agnostic abstract application package 606, intelligent translation at deployment time 608, cloud capability specific descriptors 610, distributed controllers 612, cluster A 614A, and cluster B 614B.

In turn, cluster A 614A comprises vendor A power manager 616, management node 620, agent 622A, agent 622B, agent 622C, cores 624A, cores 624B, and cores 624C. And, in turn, cluster B 614B comprises vendor B operator 626, and applications 628.

System architecture 600 can illustrate an example of power savings using application-specific C/P states tuning, where late binding is implemented for an application based on whether the application will be run on cluster A 614A or cluster B 614B.

In some examples, central processing unit (CPU) power optimization flow can be implemented as follows. The present techniques can be implemented to avoid a need for a SMO to understand all minor capabilities available in clusters. The present techniques can also be implemented to avoid a situation where a VNFD designer needs to have prior knowledge of a power-manager deployed, and VNF-required profiles to be onboarded.

In some examples, power profiles can be optional, and an application can still be deployed if a power profile is unavailable in VNFD, or if a manager does not exist in a particular cluster.

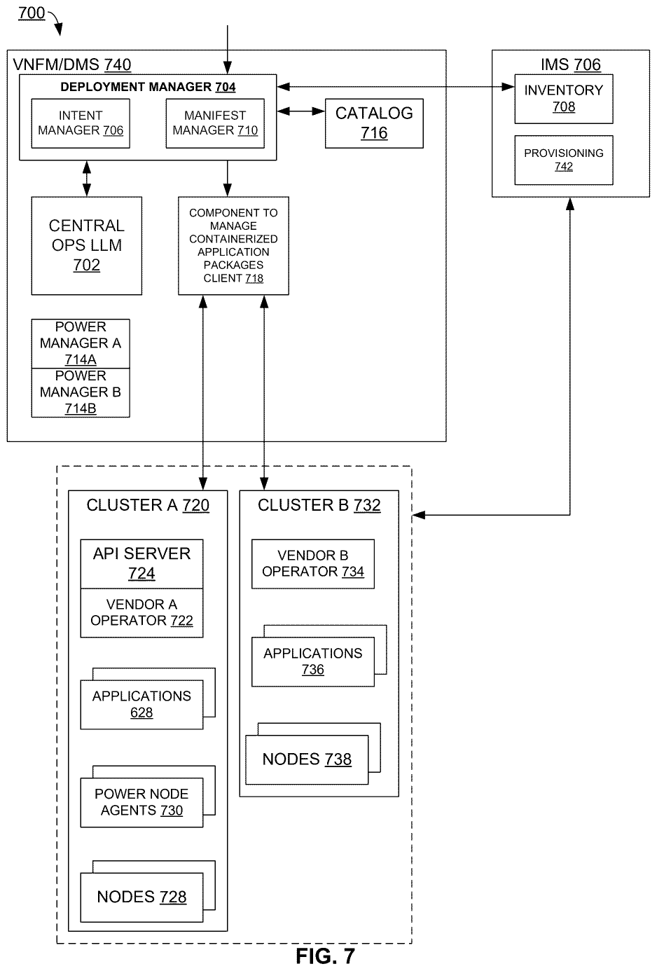

FIG. 7 illustrates an example system architecture 700 for processor power optimization, and that can facilitate late binding and package translation for multi-cloud deployment using GenAI, in accordance with an embodiment of this disclosure. In some examples, part(s) of system architecture 700 can be used to implement part(s) of system architecture 100 of FIG. 1 to facilitate late binding and package translation for multi-cloud deployment using GenAI.

System architecture 700 comprises central Ops LLM 702, deployment manager 704, intent manager 706, inventory 708, manifest manager 710, registry 712, power manager A 714A, power manager B 714B, catalog 716, component to manage containerized application packages client 718, cluster A 720, vendor A operator 722, API server 724, applications 726, nodes 728, power node agents 730, cluster B 732, vendor B operator 734, applications 736, nodes 738, VNFM/deployment management services (DMS) 740, and provisioning 742.

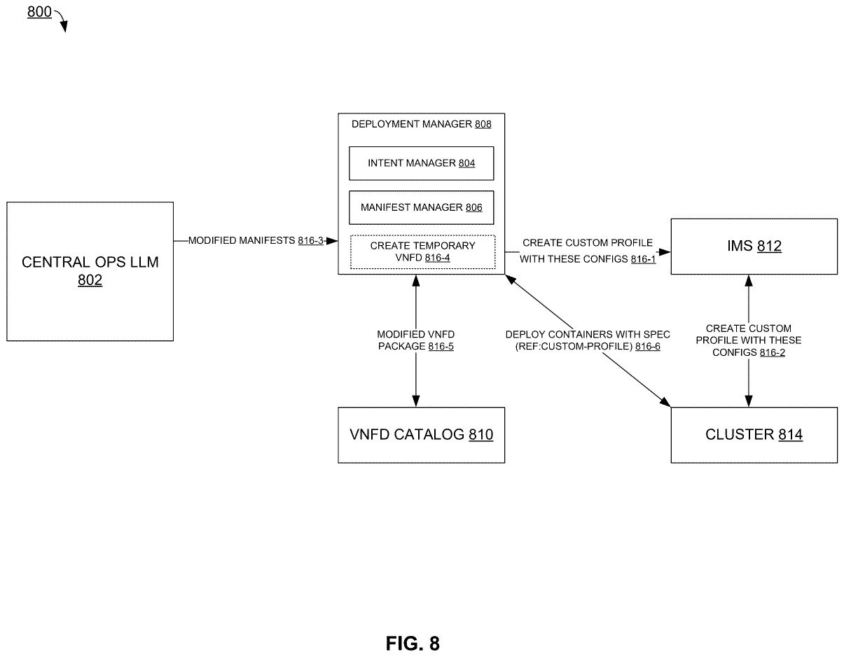

FIG. 8 illustrates an example signal flow 800 for deployment manager interactions, and that can facilitate late binding and package translation for multi-cloud deployment using GenAI, in accordance with an embodiment of this disclosure. In some examples, part(s) of signal flow 800 can be used to implement part(s) of system architecture 100 of FIG. 1 to facilitate late binding and package translation for multi-cloud deployment using GenAI.

Signal flow 800 comprises central ops LLM 802, intent manager 804, manifest manager 806, deployment manager 808, VNFD catalog 810, IMS 812, and cluster 814. Signals sent between these components are:
create custom profile with these configs 816-1;
create custom profile with these configs 816-2;
modified manifests 816-3;
create temporary VNFD 816-4;
modified VNFD package 816-5; and
deploy containers with spec (ref: custom-profile) 816-6.

In signal flow 800, custom profile creation can be performed where a profile name is created that is used in application manifest modification. In some examples, application manifest modification can be performed before custom profile creation.

Signal flow 800 can illustrate one example signal flow, where there can be other types of implementations of the present techniques. In other, similar examples, different components can perform a signal flow similar to signal flow 800.

FIG. 9 illustrates an example signal flow 900 that can facilitate late binding and package translation for multi-cloud deployment using GenAI, in accordance with an embodiment of this disclosure.

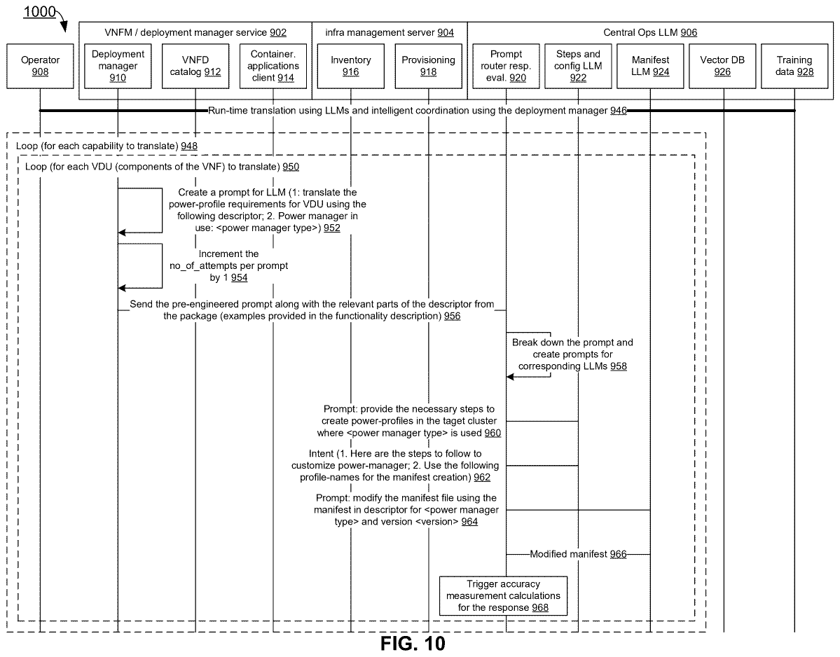

FIG. 10 illustrates more of an example signal flow 1000 that can facilitate late binding and package translation for multi-cloud deployment using GenAI, in accordance with an embodiment of this disclosure;

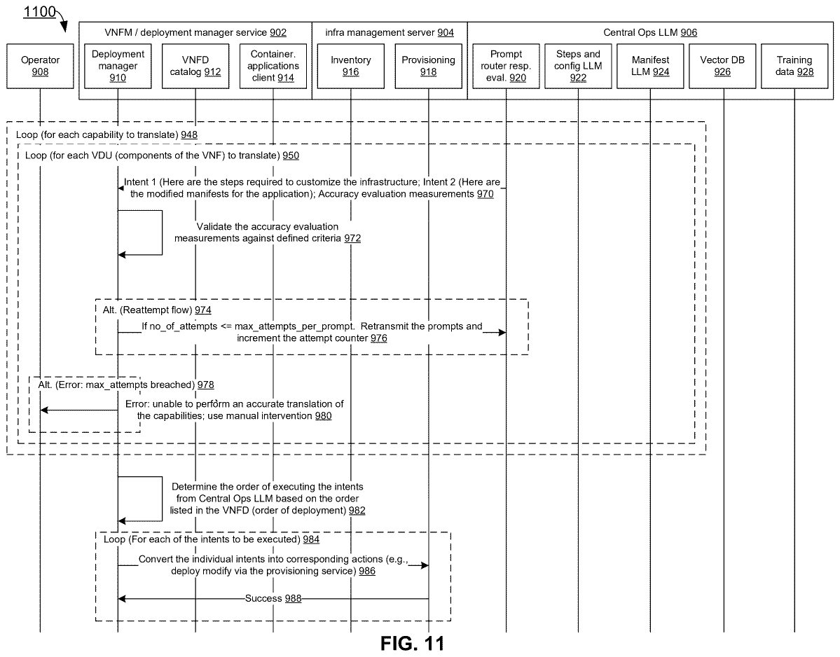

FIG. 11 illustrates more of an example signal flow 1100 that can facilitate late binding and package translation for multi-cloud deployment using GenAI, in accordance with an embodiment of this disclosure;

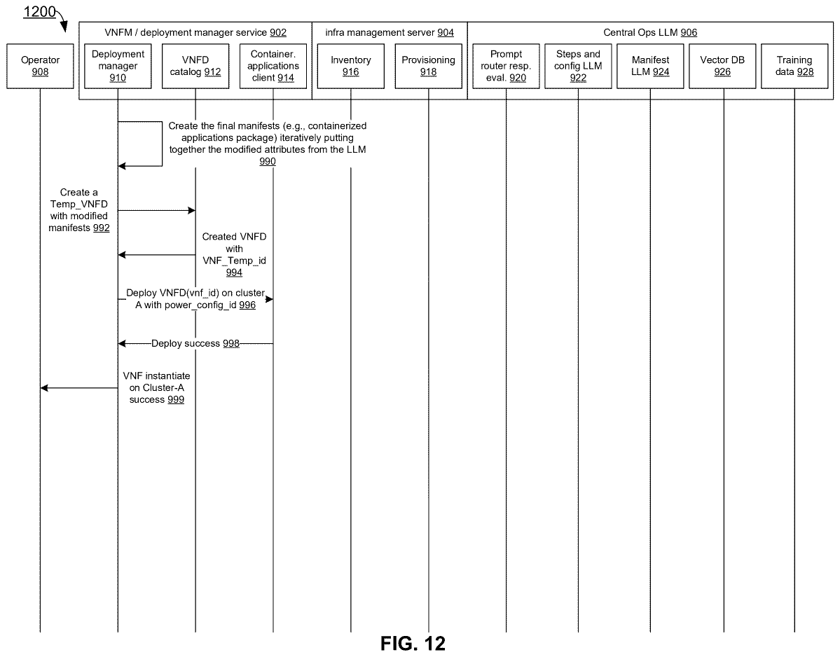

FIG. 12 illustrates more of an example signal flow 1200 that can facilitate late binding and package translation for multi-cloud deployment using GenAI, in accordance with an embodiment of this disclosure;

In some examples, part(s) of signal flows 900, 1000, 1100, and 1200 can be used to implement part(s) of system architecture 100 of FIG. 1 to facilitate late binding and package translation for multi-cloud deployment using GenAI. It can be that, together, signal flows 900, 1000, 1100, and 1200 can be implemented as a signal flow to facilitate late binding and package translation for multi-cloud deployment using GenAI.

Signal flows 900, 1000, 1100, and 1200 comprise signals between the following components: VNFM/deployment manager service 902, infra management server 904, Central Ops LLM 906, operator 908, deployment manager 910, VNFD catalog 912, containerized applications client 914, inventory 916, provisioning 918, prompt router and response evaluator 920, steps and config LLM 922, manifest LLM 924, vector DB 926, and training data 928.

The signals between these components are:
Pre-requisites 930(1 . input relevant controller(s) documents, manuals, and steps as vector embeddings into the vector DB; (2) create a fine-tuned manifest generation LLM based on the relevant example datasets containing controller(s) references; (3) the accuracy of the LLM is validated during training and testing, then moved to a production system);
Instantiate VNF 932;

### Instantiate Vnfn (vnf_id) on Cluster a 934;

Get VNFD for vnf_d id 936;
Get cluster A capabilities 938;
Process VNFD package, extract vnf_id capabilities for translation 940;
Check whether a pre-existing package that has been translated for similar requirements is available—if yes, skip below translation process 942;
No pre-existing translated package with these requirements (in metadata) 944;
Run-time translation using LLMs and intelligent coordination using the deployment manager 946;
Loop (for each capability to translate) 948;
Loop (for each VDU (components of the VNF) to translate) 950;
Create a prompt for LLM (1: translate the power-profile requirements for VDU using the following descriptor; 2. Power manager in use: <power manager type>) 952;
Increment the no_of_attempts per prompt by 1 954;
Send the pre-engineered prompt along with the relevant parts of the descriptor from the package (examples provided in the functionality description) 956;
Break down the prompt and create prompts for corresponding LLMs 958;
Prompt: provide the necessary steps to create power-profiles in the taget cluster where <power manager type>is used 960;
Intent (1. Here are the steps to follow to customize power-manager; 2. Use the following profile-names for the manifest creation) 962;
Prompt: modify the manifest file using the manifest in descriptor for <power manager type> and version <version> 964;
Modified manifest 966;
Trigger accuracy measurement calculations for the response 968;
Intent 1 (Here are the steps required to customize the infrastructure; Intent 2 (Here are the modified manifests for the application); Accuracy evaluation measurements 970;
Validate the accuracy evaluation measurements against defined criteria 972;
Alt. (Reattempt flow) 974;
If no_of_attempts<=max_attempts_per_prompt. Retransmit the prompts and increment the attempt counter 976;
Alt. (Error: max_attempts breached) 978;
Error: unable to perform an accurate translation of the capabilities; use manual intervention 980;
Determine the order of executing the intents from Central Ops LLM based on the order listed in the VNFD (order of deployment) 982;
Loop (For each of the intents to be executed) 984;
Convert the individual intents into corresponding actions (e.g., deploy modify via the provisioning service) 986;
Success 988;
Create the final manifests (e.g., containerized applications package) iteratively putting together the modified attributes from the LLM 990;
Create a Temp_VNFD with modified manifests 992;
Created VNFD with VNF_Temp_id 994;
Deploy VNFD(vnf_id) on cluster A with power_config_id 996;
Deploy success 998; and
VNF instantiate on Cluster-A success 999.

### Example Process Flows

FIG. 13 illustrates an example process flow 1300 that can facilitate late binding and package translation for multi-cloud deployment using GenAI, in accordance with an embodiment of this disclosure. In some examples, one or more embodiments of process flow 1300 can be implemented by late binding and package translation for multi-cloud deployment using GenAI component 108 of FIG. 1, or computing environment 2000 of FIG. 20.

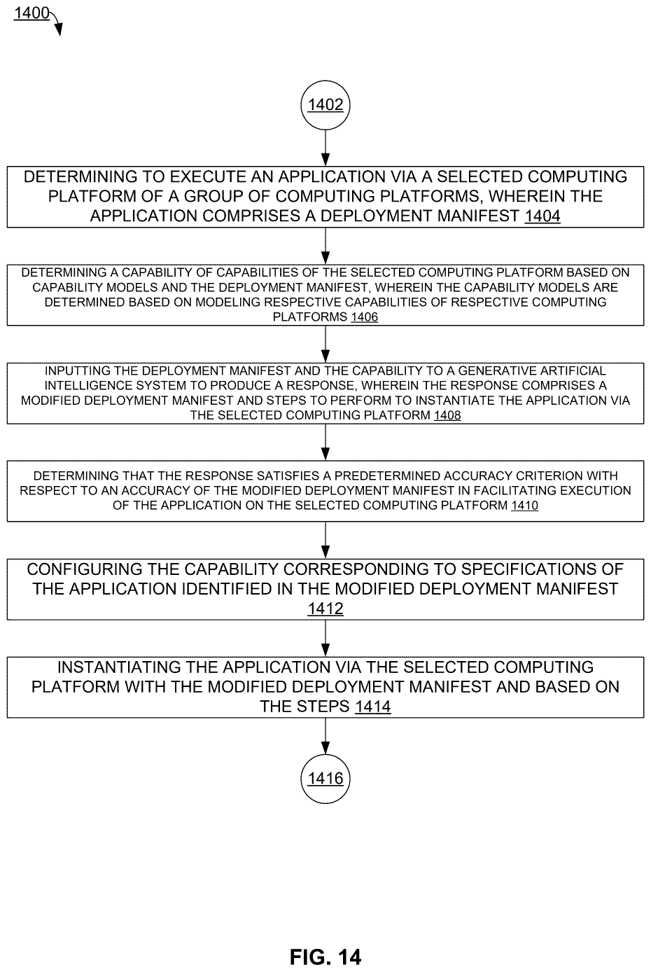

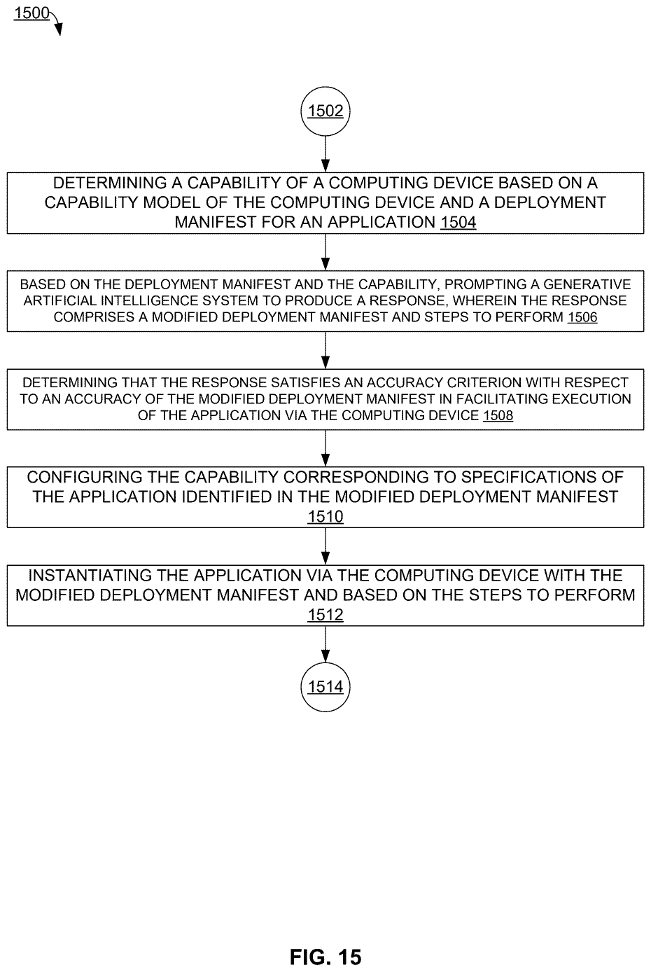

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 1400 of FIG. 14, and/or process flow 1500 of FIG. 15.

Process flow 1300 begins with 1302, and moves to operation 1304.

Operation 1304 depicts determining to execute an application via a selected computing platform of a group of computing platforms, wherein the application comprises a deployment manifest. In some examples, the application package can be for application 204 of FIG. 2, and the deployment manifest can be descriptor/manifest 206. The group of computing platforms can be similar to cluster 106A and cluster 106B of FIG. 1, where one of these clusters is selected as the selected computing platform.

After operation 1304, process flow 1300 moves to operation 1306.

Operation 1306 depicts determining a capability of capabilities of the selected computing platform based on capability models and the deployment manifest, wherein the capability models are determined based on modeling respective capabilities of respective computing platforms. In some examples, this can be implemented in a similar manner as get cluster A capabilities 938 of FIG. 9. This can comprise determining which capabilities of the selected computing platform are relevant to the application.

That is, a GenAI system can be utilized to create a deployment manifest by prompting the GenAI system, and determining that the GenAI system's output is satisfactory (which can be performed by a deployment manager). In some examples, a GenAI system can be a LLM.

After operation 1306, process flow 1300 moves to operation 1308.

Operation 1308 depicts modifying the deployment manifest based on the capability to produce a modified deployment manifest, wherein the modifying comprises prompting a generative artificial intelligence system to produce a response, wherein the response comprises the modified deployment manifest and a group of steps to perform to instantiate the application via the selected computing platform, and wherein the generative artificial intelligence system is tuned to generate manifests and configuration changes, and determining that the response satisfies an accuracy criterion with respect to an accuracy of the modified deployment manifest in facilitating execution of the application on the selected computing platform. In some examples, this can be implemented in a similar manner as 948-980 of FIGS. 10-11.

In some examples, the prompting of the generative artificial intelligence system comprises providing the generative artificial intelligence system with a prompt, and wherein at least a portion of the prompt is generated prior to the determining to execute the application via the selected computing platform.

In some examples, the prompting of the generative artificial intelligence system comprises providing the generative artificial intelligence system with a prompt, and wherein the prompt comprises a type of controller of the selected computing platform to be used by the application. In some examples, the type of controller comprises a power manager type or an accelerator type.

In some examples, the prompting of the generative artificial intelligence system comprises providing the generative artificial intelligence system with a prompt, and wherein the prompt comprises a chart of the selected computing platform to be used by the application.

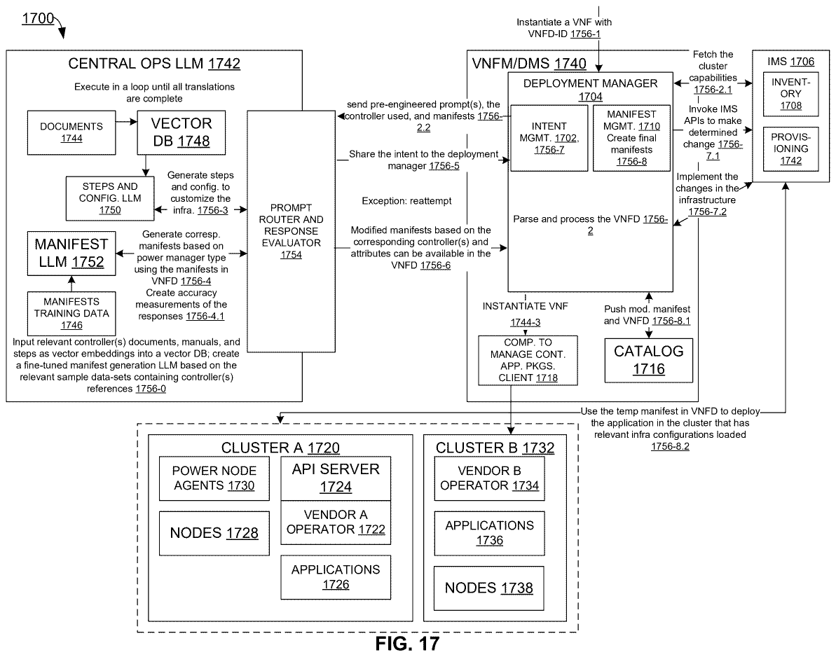

This can be similar to send pre-engineered prompt(s), the controller used, and manifests 1756-2.2 of FIG. 17.

In some examples, the group of steps to perform to instantiate the application via the selected computing platform comprises a step to perform to modify the selected computing platform, and wherein the group of steps is separate from the modified deployment manifest. This can be implemented in a similar manner as “2.2.1. To retrieve the steps and configurations used to customize the infra” of the example workflow described herein.

In some examples, the response comprises an indication of a configuration setting for the selected computing platform, and wherein the configuration setting is separate from the modified deployment manifest. This can be implemented in a similar manner as “2.2.2. To provide the manifest of the application for the controller(s)” of the example workflow described herein.

In some examples, the response comprises a first part of the response and a second part of the response, wherein the generative artificial intelligence system is a first generative artificial intelligence system, and wherein prompting the first generative artificial intelligence system to produce the response comprises creating a first part of the prompt and a second part of the prompt from a prompt; prompting the first generative artificial intelligence system with the first part of the prompt to produce the first part of the response; and prompting a second generative artificial intelligence system with the second part of the prompt to produce the second part of the response, wherein the first part of the prompt differs from the second part of the prompt, and wherein a first tuning of the first generative artificial intelligence system differs from a second tuning of the second generative artificial intelligence system. That is, a prompt router can break down the tasks, and route the prompts to relevant GenAI systems.

After operation 1308, process flow 1300 moves to operation 1310.

Operation 1310 depicts configuring the capability corresponding to specifications of the application identified in the modified deployment manifest. In some examples, this can be implemented in a similar manner as create the final manifests (e.g., containerized applications package) iteratively putting together the modified attributes from the LLM 990 of FIG. 12. This can comprise configuring the selected computing platform's capability.

After operation 1310, process flow 1300 moves to operation 1312.

Operation 1312 depicts instantiating the application via the selected computing platform with the modified deployment manifest and according to the group of steps. In some examples, this can be implemented in a similar manner as deploy VNFD(vnf_id) on cluster A with power_config_id 996 of FIG. 12. This can comprise instantiating the application on the selected computing platform.

After operation 1312, process flow 1300 moves to 1314, where process flow 1300 ends.

FIG. 14 illustrates an example process flow 1400 that can facilitate late binding and package translation for multi-cloud deployment using GenAI, in accordance with an embodiment of this disclosure. In some examples, one or more embodiments of process flow 1400 can be implemented by late binding and package translation for multi-cloud deployment using GenAI component 108 of FIG. 1, or computing environment 2000 of FIG. 20.

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of one or more of process flow 1300 of FIG. 13, and/or process flow 1500 of FIG. 15.

Process flow 1400 begins with 1402, and moves to operation 1404.

Operation 1404 depicts determining to execute an application via a selected computing platform of a group of computing platforms, wherein the application comprises a deployment manifest. In some examples, operation 1404 can be implemented in a similar manner as operation 1304 of FIG. 13.

In some examples, operation 1404 comprises, before performing the determining to execute the application, creating vector embeddings for a controller document of a controller of the selected computing platform; storing the vector embeddings in a database; and training a retrieval-augmented generation system that comprises the generative artificial intelligence system based on the database.

In some examples, operation 1404 comprises, before performing the determining to execute the application, creating vector embeddings for a first manual of the application or a second manual of the selected computing platform; storing the vector embeddings in a database; and training a retrieval-augmented generation system that comprises the generative artificial intelligence system based on the database. This can be similar to pre-requisites 930 of FIG. 9.

After operation 1404, process flow 1400 moves to operation 1406.

Operation 1406 depicts determining a capability of capabilities of the selected computing platform based on capability models and the deployment manifest, wherein the capability models are determined based on modeling respective capabilities of respective computing platforms. In some examples, operation 1406 can be implemented in a similar manner as operation 1306 of FIG. 13.

After operation 1406, process flow 1400 moves to operation 1408.

Operation 1408 depicts inputting the deployment manifest and the capability to a generative artificial intelligence system to produce a response, wherein the response comprises a modified deployment manifest and steps to perform to instantiate the application via the selected computing platform. In some examples, operation 1408 can be implemented in a similar manner as operation 1308 of FIG. 13 as applied to prompting a GenAI system.

After operation 1408, process flow 1400 moves to operation 1410.

Operation 1410 depicts determining that the response satisfies a predetermined accuracy criterion with respect to an accuracy of the modified deployment manifest in facilitating execution of the application on the selected computing platform. In some examples, operation 1410 can be implemented in a similar manner as operation 1308 of FIG. 13 as applied to determining that the response satisfies an accuracy criterion.

In some examples, the determining that the response satisfies the predetermined accuracy criterion comprises performing respective iterations of the inputting to the generative artificial intelligence system to produce respective iterative responses that comprise the response, until the response satisfies the predetermined accuracy criterion. This can be implemented in a similar manner as 974-976 of FIG. 11.

In some examples, a deployment manager of the system performs the respective iterations of the inputting to the generative artificial intelligence system, and wherein the deployment manager performs the determining that the response satisfies the predetermined accuracy criterion. That is, a deployment manager can determine whether the GenAI system's output is satisfactory, and where it is unsatisfactory, prompt the GenAI system to produce a new output (such as by providing a new prompt).

After operation 1410, process flow 1400 moves to operation 1412.

Operation 1412 depicts configuring the capability corresponding to specifications of the application identified in the modified deployment manifest. In some examples, operation 1412 can be implemented in a similar manner as operation 1310 of FIG. 13.

After operation 1412, process flow 1400 moves to operation 1414.

Operation 1414 depicts instantiating the application via the selected computing platform with the modified deployment manifest and based on the steps. In some examples, operation 1414 can be implemented in a similar manner as operation 1312 of FIG. 13.

In some examples, a deployment manager of the system performs the determining to execute the application, the determining of the capability, the inputting, the determining that the response satisfies the accuracy criterion, the configuring, and the instantiating. That is, a deployment manager can perform various operations.

After operation 1414, process flow 1400 moves to 1416, where process flow 1400 ends.

FIG. 15 illustrates an example process flow 1500 that can facilitate late binding and package translation for multi-cloud deployment using GenAI, in accordance with an embodiment of this disclosure. In some examples, one or more embodiments of process flow 1500 can be implemented by late binding and package translation for multi-cloud deployment using GenAI component 108 of FIG. 1, or computing environment 2000 of FIG. 20.

It can be appreciated that the operating procedures of process flow 1500 are example operating procedures, and that there can be embodiments that implement more or fewer operating procedures than are depicted, or that implement the depicted operating procedures in a different order than as depicted. In some examples, process flow 1500 can be implemented in conjunction with one or more embodiments of one or more of process flow 1300 of FIG. 13, and/or process flow 1400 of FIG. 14.

Process flow 1500 begins with 1502, and moves to operation 1504.

Operation 1504 depicts determining a capability of a computing device based on a capability model of the computing device and a deployment manifest for an application. In some examples, operation 1504 can be implemented in a similar manner as operation 1306 of FIG. 13.

In some examples, operation 1504 comprises, before performing the determining of the capability, creating a vector embedding for the steps to perform; storing the vector embedding in a database; and training the generative artificial intelligence system for manifest creation based on the database.

In some examples, operation 1504 comprises, before performing the determining of the capability, creating a vector embedding for a software development kit of the computing device; storing the vector embedding in a database; and training a retrieval-augmented generation system that comprises the generative artificial intelligence system based on the database.

In some examples, operation 1504 comprises, before performing the determining of the capability, creating a vector embedding for an application programming interface of the computing device; storing the vector embedding in a database; and training the generative artificial intelligence system based on the database.

In some examples, operation 1504 comprises tuning the generative artificial intelligence system based on sample datasets that comprise controller references.

This can be similar to pre-requisites 930 of FIG. 9.

After operation 1504, process flow 1500 moves to operation 1506.

Operation 1506 depicts, based on the deployment manifest and the capability, prompting a generative artificial intelligence system to produce a response, wherein the response comprises a modified deployment manifest and steps to perform. In some examples, operation 1506 can be implemented in a similar manner as operation 1308 of FIG. 13 as applied to prompting a GenAI system.

After operation 1506, process flow 1500 moves to operation 1508.

Operation 1508 depicts determining that the response satisfies an accuracy criterion with respect to an accuracy of the modified deployment manifest in facilitating execution of the application via the computing device. In some examples, operation 1508 can be implemented in a similar manner as operation 1308 of FIG. 13 as applied to determining that the response satisfies an accuracy criterion.

In some examples, the accuracy criterion indicates a likelihood that the response comprises a hallucination of the generative artificial intelligence system. A hallucination can generally comprise a response to a prompt that is inaccurate.

After operation 1508, process flow 1500 moves to operation 1510.

Operation 1510 depicts configuring the capability corresponding to specifications of the application identified in the modified deployment manifest. In some examples, operation 1510 can be implemented in a similar manner as operation 1310 of FIG. 13.

After operation 1510, process flow 1500 moves to operation 1512.

Operation 1512 depicts instantiating the application via the computing device with the modified deployment manifest and based on the steps to perform. In some examples, operation 1512 can be implemented in a similar manner as operation 1312 of FIG. 13.

After operation 1512, process flow 1500 moves to 1514, where process flow 1500 ends.

### Example Architectures, etc.

There can be a problem where an application and its workloads are currently deployed with a configuration (e.g., a power profile), but the traffic and utilization of the application that were projected for the configuration can change over time. That is, it can be that applications and their workloads can be characterized by alternating periods of high and low utilization.

An application can comprise multiple components and/or microservices. Each component/microservice that is part of an application can have multiple configurations (e.g., multiple power profiles), with corresponding abstract values, defined as part of an application package. A default configuration can be considered when instantiating each component/microservice of an application.

It can be that, during a period of low utilization, a default profile (which can generally be defined for high performance) is not efficient. Therefore, there can be a desire to closely watch an application's utilization to select an appropriate configuration that is predefined in a provided application package.

To overcome these problems with deploying applications/workloads, the present techniques can be implemented to facilitate a closed-loop policy that comprises rules delivered by an application provider on a configuration that is suitable for utilization of an application.

A policy can comprise logic to select between profiles. Using a power profile example, a policy can comprise power-in and power-out logics—that is, logic, triggers, and actions to move from a default power profile to a predefined power savings profile (power-in) and vice versa (power out). “Power in” (to invoke power savings, to enter into a higher power-savings state) and “power out” (to reduce power savings, to exit from a higher power-savings state) can be terms that are similar to “scale in” and “scale out” (which can refer to scaling a system).

An action recommended by an entity executing a policy (e.g., a policy manager) can be applied directly to infrastructure resources that the microservices of an application are currently using directly in the form of a config update. This can avoid a need to redeploy the microservices (or pods in which the microservices execute), as it can be that there are no changes to the application manifest. Rather the configurations (e.g., power profile configurations) can be updated by a deployment manager.

The following can be generally implemented in prior approaches, while the present techniques can extend it for autonomous power management. VNF modification flow can be supported based on configurable properties of a VNF instance, without a need to redeploy the VNF instance to enable auto-scaling and auto-healing of that VNF instance. The present techniques can be implemented to extend a VNF modification flow to facilitate autonomous management (e.g., auto power management) of a particular VNF instance, which could have been disabled at a time of instantiation.

A modified custom profile file can be sent to IMS to be applied in the target cluster. The IMS can deploy the custom profile file, which can have an effect of a configuration update of the cluster capability that was already in place.

The computing cores associated with the relevant workloads can be modified per this latest configuration, without a need to redeploy the workload.

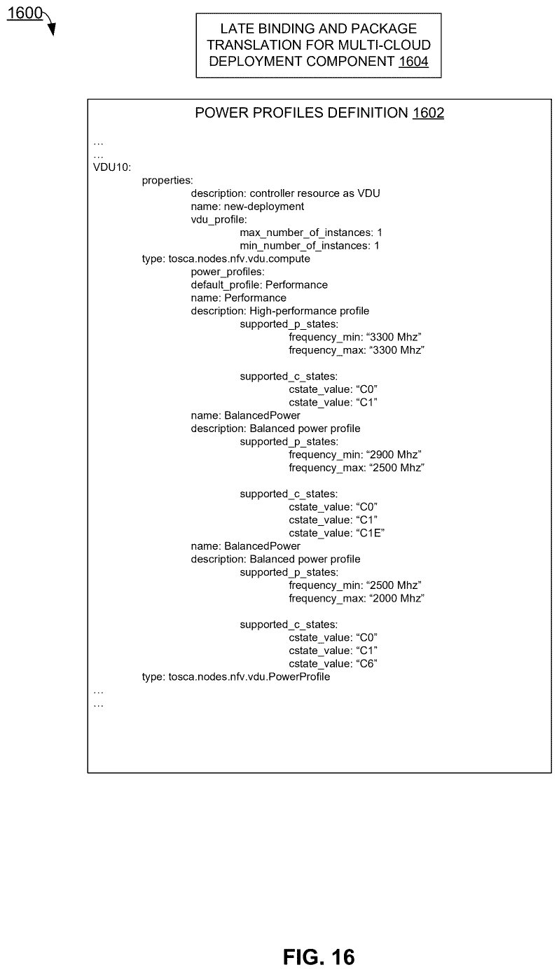

FIG. 16 illustrates an example power profiles definition 1600, and that can facilitate late binding and package translation for multi-cloud deployment using GenAI, in accordance with an embodiment of this disclosure. In some examples, part(s) of power profiles definition 1600 can be used to implement part(s) of system architecture 100 of FIG. 1 to facilitate late binding and package translation for multi-cloud deployment using GenAI.

Power profiles definition 1600 comprises power profiles definition 1602 and late binding and package translation for multi-cloud deployment using GenAI component 1604 (which can be similar to late binding and package translation for multi-cloud deployment using GenAI component 108 of FIG. 1).

FIG. 16 illustrates an example of a power profiles definition in an application package. Abstract values can be included as part of a VNFD.

FIG. 17 illustrates an example system architecture 1700 for dynamic configuration switching, and that can facilitate late binding and package translation for multi-cloud deployment using GenAI, in accordance with an embodiment of this disclosure. In some examples, part(s) of system architecture 1700 can be used to implement part(s) of system architecture 100 of FIG. 1 to facilitate late binding and package translation for multi-cloud deployment using GenAI.

System architecture 1700 comprises intent management 1702, deployment manager 1704, infrastructure IMS 1706, inventory 1708, manifest management 1710, catalog 1716, component to manage containerized application packages client 1718, cluster A 1720, vendor A operator 1722, API server 1724, applications 1726, nodes 1728, power node agents 1730, cluster B 1732, vendor B operator 1734, applications 1736, nodes 1738, VNFM/deployment management services (DMS) 1740, central ops LLM 1742, documents 1744, manifests training data 1746, vector DB 1748, steps and configuration LLM 1750, manifest LLM 1752, and prompt router and response evaluator 1754.

System architecture 1700 also comprises various signal flows:
Input relevant controller(s) documents, manuals, and steps as vector embeddings into a vector DB; create a fine-tuned manifest generation LLM based on the relevant sample data-sets containing controller(s) references 1756-0;
Instantiate a VNF with VNFD-ID 1756-1;
Parse and process the VNFD 1756-2;
Fetch the cluster capabilities 1756-2.1;
Send pre-engineered prompt(s), the controller used, and manifests 1756-2.2;
Generate the steps and configuration to customize the infrastructure based on the controller used and power-profiles in the application manifest 1756-3;
Generate the corresponding manifests based on the power manager type using the manifests available in VNFD 1756-4;
Create accuracy measurements of the responses 1756-4.1;
Share the intent to the deployment manager 1756-5;
Modified manifests based on the corresponding controller(s) and attributes can be available in the VNFD 1756-6;
Intent management 1756-7;
Invoke the IMS APIs to make the determined changes 1756-7.1;
The IMS implements the changes in the infrastructure 1756-7.2;
Create the final manifests based on LLM and other relevant translations 1756-8;
Push the modified manifest and VNFD to the catalogue 1756-8.1; and
Use the temp manifest in VNFD to deploy the application in the cluster that has relevant infra configurations loaded 1756-8.2.

A VNF modification flow can be extended from auto scaling and auto healing (which can generally be according to some existing standards) to automatically performing other functions (like auto power management).

These techniques can be implemented for central processing unit power control and optimization, as well as other deployment optimization scenarios.

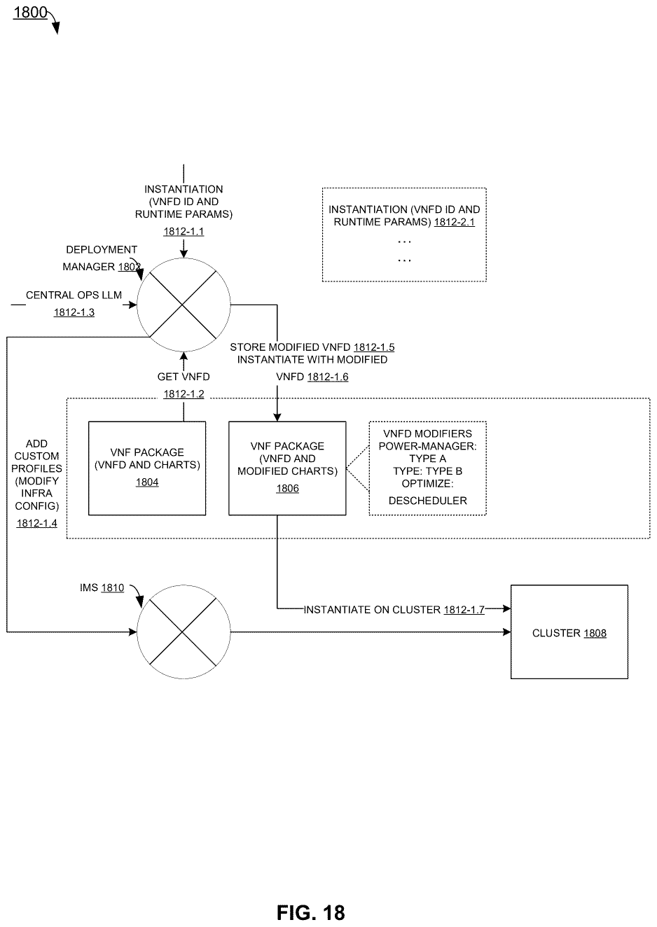

FIG. 18 illustrates an example system architecture 1800 for instantiating an application on a cluster type a first time, and that can facilitate late binding and package translation for multi-cloud deployment using GenAI, in accordance with an embodiment of this disclosure. In some examples, part(s) of system architecture 1800 can be used to implement part(s) of system architecture 100 of FIG. 1 to facilitate late binding and package translation for multi-cloud deployment using GenAI,

System architecture 1800 comprises deployment manager 1802, VNF package (VNFD and charts) 1804, VNF package (VNFD and modified charts) 1806, cluster 1808, and IMS 1810.

System architecture 1800 also comprises various signal flows:
instantiation (VNFD ID and runtime params) 1812-1.1
get VNFD 1812-1.2
central ops LLM 1812-1.3
add custom profiles (modify infra config) 1812-1.4
store modified VNFD 1812-1.5
instantiate with modified VNFD 1812-1.6
instantiate on cluster 1812-1.7
instantiation (VNFD ID and runtime params) 1812-2.1

System architecture 1800 comprises deployment manager 1802, VNF package (VNFD and charts) 1804, VNF package (VNFD and modified charts) 1806, cluster 1808, and IMS 1810.

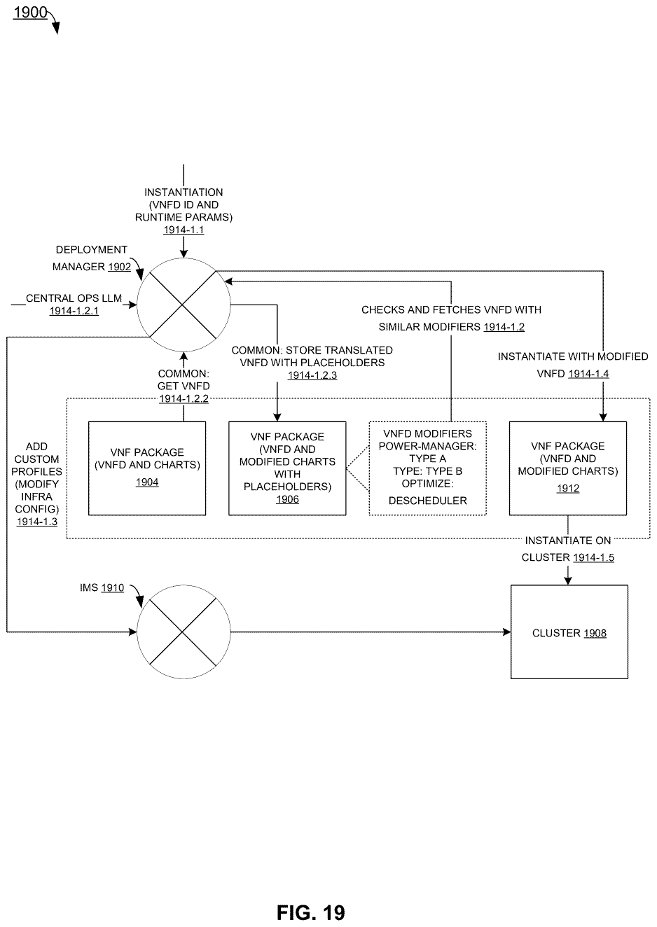

Generally, FIG. 18 illustrates an unoptimized flow where there is no reusability (in contrast to the reusability illustrated in FIG. 19). For one instantiation request, 1812-1.1 through 1812-1.7 can be performed. Then, for a subsequent instantiation request, that entire process can be repeated (indicated by instantiation (VNFD ID and runtime params) 1812-2.1, which can be similar to 1812-1.1), which can be less efficient compared to the reusability techniques illustrated in FIG. 19.

FIG. 19 illustrates an example system architecture 1900 for instantiating an application on a cluster type a subsequent time, and that can facilitate late binding and package translation for multi-cloud deployment using GenAI, in accordance with an embodiment of this disclosure. In some examples, part(s) of system architecture 1900 can be used to implement part(s) of system architecture 100 of FIG. 1 to facilitate late binding and package translation for multi-cloud deployment using GenAI.

In contrast to FIG. 18, which illustrates an example that does not implement reusability in application instantiation, in FIG. 19, there can be reusability in application instantiation for a similar cluster type.

System architecture 1900 comprises deployment manager 1902, VNF package (VNFD and charts) 1904, VNF package (VNFD and modified charts with placeholders) 1906, cluster 1908, IMS 1910, and VNF package (VNFD and modified charts) 1912.

System architecture 1900 also comprises various signal flows:
instantiation (VNFD ID and runtime params) 1914-1.1
checks and fetches VNFD with similar modifiers 1914-1.2
central ops LLM 1914-1.2.1
common: get VNFD 1914-1.2.2
common: store translated VNFD with placeholders 1914-1.2.3
add custom profiles (modify infra config) 1914-1.3
instantiate with modified VNFD 1914-1.4
instantiate on cluster 1914-1.5

Certain of these signal flows can be noted as “common” because they are similar to corresponding signal flows in FIG. 18. It can be that the signal flows of FIG. 18 can be used to instantiate an application on a cluster a first time. Then, the signal flows of FIG. 19 can be used to reuse parts of FIG. 18, where the same application of FIG. 18 is instantiated on a different cluster type.

The present techniques can facilitate reusability. That is, where a user requests a subsequent instantiation for a same application but for a different cluster type, a new modified descriptor can be generated. Where it is the same application for a similar cluster type and similar capabilities, a pre-existing descriptor can be used, saving on processing delay.

### Example Operating Environment

In order to provide additional context for various embodiments described herein, FIG. 20 and the following discussion are intended to provide a brief, general description of a suitable computing environment 2000 in which the various embodiments of the embodiment described herein can be implemented.

For example, parts of computing environment 2000 can be used to implement one or more embodiments of computer system 102, cluster 106A, and/or cluster 106B.

In some examples, computing environment 2000 can implement one or more embodiments of the signal flows of FIGS. 9-12 and/or the process flows of FIGS. 13-15 to facilitate late binding and package translation for multi-cloud deployment using GenAI.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 20, the example environment 2000 for implementing various embodiments described herein comprises processing unit 2002, system memory 2004, power supply unit 2006, accelerator 2008, network adapter 2010, bus 2012, operating system 2014, device drivers 2016, data 2018, applications 2020, infrastructure manager 2022, deployment manager 2024, policy manager 2026, and other modules 2028.

The system bus 2012 couples system components including, but not limited to, the system memory 2004 to the processing unit 2002. The processing unit 2002 can be any of various commercially available processors. Dual microprocessors and other multi-processor architectures can also be employed as the processing unit 2002.

The system bus 2012 can be any of several types of bus structure that can further interconnect to a memory bus (with or without a memory controller), a peripheral bus, and a local bus using any of a variety of commercially available bus architectures. The system memory 2004 can include ROM and RAM. A basic input/output system (BIOS) can be stored in a nonvolatile storage such as ROM, erasable programmable read only memory (EPROM), EEPROM, which BIOS contains the basic routines that help to transfer information between elements within a computer of computing environment 2000, such as during startup. The RAM can also include a high-speed RAM such as static RAM for caching data.

The drives and their associated computer-readable storage media provide nonvolatile storage of data, data structures, computer-executable instructions, and so forth. For a computer of computing environment 2000, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM, including an operating system 2014, device drivers 2016, data 2018, and applications 2020. All portions of the operating system, applications, modules, and/or data can also be cached in RAM. The systems and methods described herein can be implemented utilizing various commercially available operating systems or combinations of operating systems.

Computing environment 2000 can optionally comprise emulation technologies. For example, a hypervisor (not shown) or other intermediary can emulate a hardware environment for operating system 2014, and the emulated hardware can optionally be different from the hardware illustrated in FIG. 20. In such an embodiment, operating system 2014 can comprise one virtual machine (VM) of multiple VMs hosted at computing environment 2000. Furthermore, operating system 2014 can provide runtime environments, such as the Java runtime environment or the .NET framework, for applications 2020. Runtime environments are consistent execution environments that allow applications 2020 to run on any operating system that includes the runtime environment. Similarly, operating system 2014 can support containers, and applications 2020 can be in the form of containers, which are lightweight, standalone, executable packages of software that include, e.g., code, runtime, system tools, system libraries and settings for an application.

Further, computing environment 2000 can be enabled with a security module, such as a trusted processing module (TPM). For instance, with a TPM, boot components hash next in time boot components, and wait for a match of results to secured values, before loading a next boot component. This process can take place at any layer in the code execution stack of computing environment 2000, e.g., applied at the application execution level or at the operating system (OS) kernel level, thereby enabling security at any level of code execution.

A user can enter commands and information into the computing environment 2000 through one or more wired/wireless input devices, e.g., a keyboard, a touch screen, and a pointing device, such as a mouse. Other input devices can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2002 through an input device interface that can be coupled to the system bus 2012, but can be connected by other interfaces, such as a parallel port, an IEEE 1394 serial port, a game port, a USB port, an IR interface, a BLUETOOTH® interface, etc.

A monitor or other type of display device can be also connected to the system bus 2012 via an interface, such as a video adapter. In addition to the monitor, a computer can include other peripheral output devices (not shown), such as speakers, printers, etc.

Computing environment 2000 can operate in a networked environment using logical connections via wired and/or wireless communications to one or more remote computers, such as a remote computer(s). The remote computer(s) can be a workstation, a server computer, a router, a personal computer, portable computer, microprocessor-based entertainment appliance, a peer device or other common network node, and typically includes many or all of the elements described relative to the computing environment 2000, although, for purposes of brevity, only a memory/storage device is illustrated. The logical connections depicted include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, all of which can connect to a global communications network, e.g., the Internet.

When used in a LAN networking environment, the computing environment 2000 can be connected to the local network through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, the computing environment 2000 can include a modem or can be connected to a communications server on the WAN via other means for establishing communications over the WAN, such as by way of the Internet. The modem, which can be internal or external and a wired or wireless device, can be connected to the system bus 2012 via the input device interface. In a networked environment, program modules depicted relative to the computing environment 2000 or portions thereof, can be stored in the remote memory/storage device. It will be appreciated that the network connections shown are examples, and other means of establishing a communications link between the computers can be used.

When used in either a LAN or WAN networking environment, the computing environment 2000 can access cloud storage systems or other network-based storage systems in addition to, or in place of, external storage devices as described above. Generally, a connection between the computing environment 2000 and a cloud storage system can be established over a LAN or 2056 e.g., by the adapter or modem, respectively. Upon connecting the computing environment 2000 to an associated cloud storage system, the external storage interface can, with the aid of the adapter and/or modem, manage storage provided by the cloud storage system as it would other types of external storage. For instance, an external storage interface can be configured to provide access to cloud storage sources as if those sources were physically connected to the computing environment 2000.

The computing environment 2000 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Computing environment 2000 can comprise infrastructure manager 2022, deployment manager 2024, policy manager 2026, and other modules 2028, which can be utilized to implement the present techniques.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
determining to execute an application via a selected computing platform of a group of computing platforms, wherein the application comprises a deployment manifest;
determining a capability of capabilities of the selected computing platform based on capability models and the deployment manifest, wherein the capability models are determined based on modeling respective capabilities of respective computing platforms;
modifying the deployment manifest based on the capability to produce a modified deployment manifest, wherein the modifying comprises,
prompting a generative artificial intelligence system to produce a response, wherein the response comprises the modified deployment manifest and a group of steps to perform to instantiate the application via the selected computing platform, and wherein the generative artificial intelligence system is tuned to generate manifests and configuration changes, and
determining that the response satisfies an accuracy criterion with respect to an accuracy of the modified deployment manifest in facilitating execution of the application on the selected computing platform;
configuring the capability corresponding to specifications of the application identified in the modified deployment manifest; and
instantiating the application via the selected computing platform with the modified deployment manifest and according to the group of steps.

2. The system of claim 1, wherein the prompting of the generative artificial intelligence system comprises providing the generative artificial intelligence system with a prompt, and wherein at least a portion of the prompt is generated prior to the determining to execute the application via the selected computing platform.

3. The system of claim 1, wherein the prompting of the generative artificial intelligence system comprises providing the generative artificial intelligence system with a prompt, and wherein the prompt comprises a type of controller of the selected computing platform to be used by the application.

4. The system of claim 3, wherein the type of controller comprises a power manager type or an accelerator type.

5. The system of claim 1, wherein the prompting of the generative artificial intelligence system comprises providing the generative artificial intelligence system with a prompt, and wherein the prompt comprises a chart of the selected computing platform to be used by the application.

6. The system of claim 1, wherein the group of steps to perform to instantiate the application via the selected computing platform comprises a step to perform to modify the selected computing platform, and wherein the group of steps is separate from the modified deployment manifest.

7. The system of claim 1, wherein the response comprises an indication of a configuration setting for the selected computing platform, and wherein the configuration setting is separate from the modified deployment manifest.

8. The system of claim 1, wherein the response comprises a first part of the response and a second part of the response, wherein the generative artificial intelligence system is a first generative artificial intelligence system, and wherein prompting the first generative artificial intelligence system to produce the response comprises:
creating a first part of the prompt and a second part of the prompt from a prompt;
prompting the first generative artificial intelligence system with the first part of the prompt to produce the first part of the response; and
prompting a second generative artificial intelligence system with the second part of the prompt to produce the second part of the response, wherein the first part of the prompt differs from the second part of the prompt, and wherein a first tuning of the first generative artificial intelligence system differs from a second tuning of the second generative artificial intelligence system.

9. A method, comprising:
determining, by a system comprising at least one processor, to execute an application via a selected computing platform of a group of computing platforms, wherein the application comprises a deployment manifest;
determining, by the system, a capability of capabilities of the selected computing platform based on capability models and the deployment manifest, wherein the capability models are determined based on modeling respective capabilities of respective computing platforms;
inputting, by the system, the deployment manifest and the capability to a generative artificial intelligence system to produce a response, wherein the response comprises a modified deployment manifest and steps to perform to instantiate the application via the selected computing platform;
determining, by the system, that the response satisfies a predetermined accuracy criterion with respect to an accuracy of the modified deployment manifest in facilitating execution of the application on the selected computing platform;
configuring, by the system, the capability corresponding to specifications of the application identified in the modified deployment manifest; and
instantiating, by the system, the application via the selected computing platform with the modified deployment manifest and based on the steps.

10. The method of claim 9, wherein the determining that the response satisfies the predetermined accuracy criterion comprises:
performing, by the system, respective iterations of the inputting to the generative artificial intelligence system to produce respective iterative responses that comprise the response, until the response satisfies the predetermined accuracy criterion.

11. The method of claim 10, wherein a deployment manager of the system performs the respective iterations of the inputting to the generative artificial intelligence system, and wherein the deployment manager performs the determining that the response satisfies the predetermined accuracy criterion.

12. The method of claim 9, wherein a deployment manager of the system performs the determining to execute the application, the determining of the capability, the inputting, the determining that the response satisfies the accuracy criterion, the configuring, and the instantiating.

13. The method of claim 9, further comprising:
before performing the determining to execute the application, creating, by the system, vector embeddings for a controller document of a controller of the selected computing platform;
storing, by the system, the vector embeddings in a database; and
training, by the system, a retrieval-augmented generation system that comprises the generative artificial intelligence system based on the database.

14. The method of claim 9, further comprising:
before performing the determining to execute the application, creating, by the system, vector embeddings for a first manual of the application or a second manual of the selected computing platform;
storing, by the system, the vector embeddings in a database; and
training, by the system, a retrieval-augmented generation system that comprises the generative artificial intelligence system based on the database.

15. A non-transitory computer-readable medium comprising instructions that, in response to execution, cause a system comprising at least one processor to perform operations, comprising:
determining a capability of a computing device based on a capability model of the computing device and a deployment manifest for an application;
based on the deployment manifest and the capability, prompting a generative artificial intelligence system to produce a response, wherein the response comprises a modified deployment manifest and steps to perform;
determining that the response satisfies an accuracy criterion with respect to an accuracy of the modified deployment manifest in facilitating execution of the application via the computing device;
configuring the capability corresponding to specifications of the application identified in the modified deployment manifest; and
instantiating the application via the computing device with the modified deployment manifest and based on the steps to perform.

16. The non-transitory computer-readable medium of claim 15, wherein the operations further comprise:
before performing the determining of the capability, creating a vector embedding for the steps to perform;
storing the vector embedding in a database; and
training the generative artificial intelligence system for manifest creation based on the database.

17. The non-transitory computer-readable medium of claim 15, wherein the operations further comprise:
before performing the determining of the capability, creating a vector embedding for a software development kit of the computing device;
storing the vector embedding in a database; and
training a retrieval-augmented generation system that comprises the generative artificial intelligence system based on the database.

18. The non-transitory computer-readable medium of claim 15, wherein the operations further comprise:
before performing the determining of the capability, creating a vector embedding for an application programming interface of the computing device;
storing the vector embedding in a database; and
training the generative artificial intelligence system based on the database.

19. The non-transitory computer-readable medium of claim 15, wherein the operations further comprise:
tuning the generative artificial intelligence system based on sample datasets that comprise controller references.

20. The non-transitory computer-readable medium of claim 15, wherein the accuracy criterion indicates a likelihood that the response comprises a hallucination of the generative artificial intelligence system.
